(19) United States
(12) Patent Application Publication
(10) Pub. No.: US 2005/0231562 A1
(43) Pub. Date: Oct. 20, 2005

(54) Fluid ejection device

(76) Inventors: Joseph M. Torgerson, Philomath, OR (US); Simon Dodd, Corvallis, OR (US); Michael D. Miller, Philomath, OR (US); Trudy L. Benjamin, Portland, OR (US); Kevin Bruce, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/827,030

(22) Filed: Apr. 19, 2004

(51) Int. Cl. B41J 2/05

(52) U.S. Cl. 347/65

(57) ABSTRACT

A fluid ejection device comprising a first fluid feed source having a first fluid feed source edge in communication with a substrate surface, first firing resistors disposed along the first fluid feed source and configured to respond to a first current to heat fluid provided by the first fluid feed source, and a reference conductor. The reference conductor is configured to conduct the first current from the first firing resistors, wherein the reference conductor is disposed between the first fluid feed source edge and the first firing resistors.

### CROSS-REFERENCE TO RELATED APPLICATIONS

This application is related to patent application Ser. No. [Not Yet Assigned], Attorney Docket No. 200209168-1, entitled “Fluid Ejection Device,” patent application Ser. No. [Not Yet Assigned], Attorney Docket No. 200208780-1, entitled “Fluid Ejection Device With Address Generator,” patent application Ser. No. [Not Yet Assigned], No. 200311485-1, entitled “Device With Gates Configured In Loop Structures,” patent application Ser. No. [Not Yet Assigned], No. 200209559-1, entitled “Fluid Ejection Device,” and patent application Ser. No. [Not Yet Assigned], Attorney Docket No. 200209237-1, entitled “Fluid Ejection Device With Identification Cells,” each of which are assigned to the Assignee of this application and are filed on even date herewith, and each of which is fully incorporated by reference as if fully set forth herein.

### BACKGROUND

An inkjet printing system, as one embodiment of a fluid ejection system, may include a printhead, an ink supply that provides liquid ink to the printhead, and an electronic controller that controls the printhead. The printhead, as one embodiment of a fluid ejection device, ejects ink drops through a plurality of orifices or nozzles. The ink is projected toward a print medium, such as a sheet of paper, to print an image onto the print medium. The nozzles are typically arranged in one or more arrays, such that properly sequenced ejection of ink from the nozzles causes characters or other images to be printed on the print medium as the printhead and the print medium are moved relative to each other.

In a typical thermal inkjet printing system, the printhead ejects ink drops through nozzles by rapidly heating small volumes of ink located in vaporization chambers. The ink is heated with small electric heaters, such as thin film resistors referred to herein as firing resistors. Heating the ink causes the ink to vaporize and be ejected through the nozzles.

To eject one drop of ink, the electronic controller that controls the printhead activates an electrical current from a power supply external to the printhead. The electrical current is passed through a selected firing resistor to heat the ink in a corresponding selected vaporization chamber and eject the ink through a corresponding nozzle. Known drop generators include a firing resistor, a corresponding vaporization chamber, and a corresponding nozzle.

As inkjet printheads have evolved, the number of drop generators in a printhead has increased to improve printing speed and/or quality. The increase in the number of drop generators per printhead has resulted in a corresponding increase in the number of input pads required on a printhead die to energize the increased number of firing resistors. In one type of printhead, each firing resistor is coupled to a corresponding input pad to provide power to energize the firing resistor. One input pad per firing resistor becomes impractical as the number of firing resistors increases.

The number of drop generators per input pad is significantly increased in another type of printhead having primitives. A single power lead provides power to all firing resistors in one primitive. Each firing resistor is coupled in series with the power lead and the drain-source path of a corresponding field effect transistor (FET). The gate of each FET in a primitive is coupled to a separately energizable address lead that is shared by multiple primitives.

Manufacturers continue reducing the number of input pads and increasing the number of drop generators on a printhead die. A printhead with fewer input pads typically costs less than a printhead with more input pads. Also, a printhead with more drop generators typically prints with higher quality and/or printing speed. To maintain costs and provide a particular printing swath height, printhead die size may not significantly change with an increased number of drop generators. As drop generator densities increase and the number of input pads decrease, printhead die layouts can become increasingly complex.

For these and other reasons, there is a need for the present invention.

### BRIEF DESCRIPTION OF THE DRAWINGS

FIG. 1 is a diagram illustrating one embodiment of an inkjet printing system.

FIG. 2 is a diagram illustrating a portion of one embodiment of a printhead die.

FIG. 3 is a diagram illustrating a layout of drop generators located along an ink feed slot in one embodiment of a printhead die.

FIG. 4 is a diagram illustrating one embodiment of a firing cell employed in one embodiment of a printhead die.

FIG. 5 is a schematic diagram illustrating one embodiment of an inkjet printhead firing cell array.

FIG. 6 is a block diagram illustrating one embodiment of a layout of a printhead die.

FIG. 7 is a block diagram illustrating one embodiment of a layout of a reference conductor in a printhead die.

FIG. 8 is a plan view diagram illustrating one embodiment of a section at a first metal layer of a printhead die.

FIG. 9A is a diagram illustrating a partial cross-section of one embodiment of a printhead die taken at the position of line 9A in FIG. 8.

FIG. 9B is a diagram illustrating a partial cross-section of one embodiment of a printhead die taken at the position of line 9B in FIG. 8.

FIG. 10 is a diagram illustrating one embodiment of a section of a printhead die at the position of line 10 in FIG. 9B.

FIG. 11 is a block diagram illustrating a layout of fire lines in one embodiment of a printhead die.

FIG. 12 is a plan view diagram illustrating one embodiment of a section of a printhead die.

FIG. 13 is a diagram illustrating a partial cross-section of one embodiment of a printhead die taken at the position of line 13 in FIG. 12.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

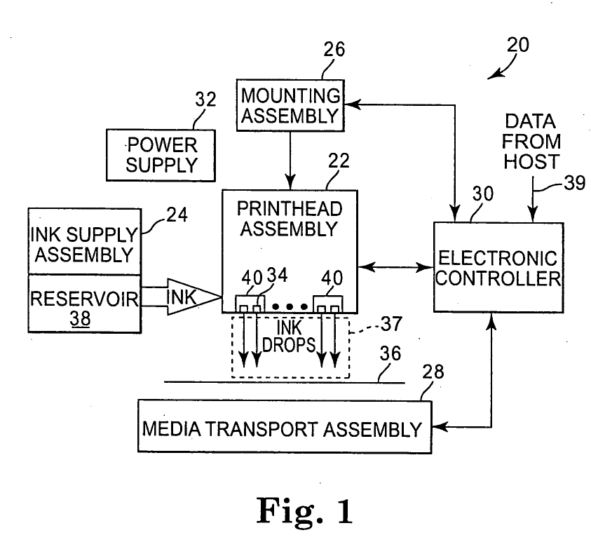

FIG. 1 illustrates one embodiment of an inkjet printing system 20. Inkjet printing system 20 constitutes one embodiment of a fluid ejection system that includes a fluid ejection device, such as inkjet printhead assembly 22, and a fluid supply assembly, such as ink supply assembly 24. The inkjet printing system 20 also includes a mounting assembly 26, a media transport assembly 28, and an electronic controller 30. At least one power supply 32 provides power to the various electrical components of inkjet printing system 20.

In one embodiment, inkjet printhead assembly 22 includes at least one printhead or printhead die 40 that ejects drops of ink through a plurality of orifices or nozzles 34 toward a print medium 36 so as to print onto print medium 36. Printhead 40 is one embodiment of a fluid ejection device. Print medium 36 may be any type of suitable sheet material, such as paper, card stock, transparencies, Mylar, fabric, and the like. Typically, nozzles 34 are arranged in one or more columns or arrays such that properly sequenced ejection of ink from nozzles 34 causes characters, symbols, and/or other graphics or images to be printed upon print medium 36 as inkjet printhead assembly 22 and print medium 36 are moved relative to each other. While the following description refers to the ejection of ink from printhead assembly 22, it is understood that other liquids, fluids or flowable materials, including clear fluid, may be ejected from printhead assembly 22.

Ink supply assembly 24 as one embodiment of a fluid supply assembly provides ink to printhead assembly 22 and includes a reservoir 38 for storing ink. As such, ink flows from reservoir 38 to inkjet printhead assembly 22. Ink supply assembly 24 and inkjet printhead assembly 22 can form either a one-way ink delivery system or a recirculating ink delivery system. In a one-way ink delivery system, substantially all of the ink provided to inkjet printhead assembly 22 is consumed during printing. In a recirculating ink delivery system, only a portion of the ink provided to printhead assembly 22 is consumed during printing. As such, ink not consumed during printing is returned to ink supply assembly 24.

In one embodiment, inkjet printhead assembly 22 and ink supply assembly 24 are housed together in an inkjet cartridge or pen. The inkjet cartridge or pen is one embodiment of a fluid ejection device. In another embodiment, ink supply assembly 24 is separate from inkjet printhead assembly 22 and provides ink to inkjet printhead assembly 22 through an interface connection, such as a supply tube (not shown). In either embodiment, reservoir 38 of ink supply assembly 24 may be removed, replaced, and/or refilled. In one embodiment, where inkjet printhead assembly 22 and ink supply assembly 24 are housed together in an inkjet cartridge, reservoir 38 includes a local reservoir located within the cartridge and may also include a larger reservoir located separately from the cartridge. As such, the separate, larger reservoir serves to refill the local reservoir. Accordingly, the separate, larger reservoir and/or the local reservoir may be removed, replaced, and/or refilled.

Mounting assembly 26 positions inkjet printhead assembly 22 relative to media transport assembly 28 and media transport assembly 28 positions print medium 36 relative to inkjet printhead assembly 22. Thus, a print zone 37 is defined adjacent to nozzles 34 in an area between inkjet printhead assembly 22 and print medium 36. In one embodiment, inkjet printhead assembly 22 is a scanning type printhead assembly. As such, mounting assembly 26 includes a carriage (not shown) for moving inkjet printhead assembly 22 relative to media transport assembly 28 to scan print medium 36. In another embodiment, inkjet printhead assembly 22 is a non-scanning type printhead assembly. As such, mounting assembly 26 fixes inkjet printhead assembly 22 at a prescribed position relative to media transport assembly 28. Thus, media transport assembly 28 positions print medium 36 relative to inkjet printhead assembly 22.

Electronic controller or printer controller 30 typically includes a processor, firmware, and other electronics, or any combination thereof, for communicating with and controlling inkjet printhead assembly 22, mounting assembly 26, and media transport assembly 28. Electronic controller 30 receives data 39 from a host system, such as a computer, and usually includes memory for temporarily storing data 39. Typically, data 39 is sent to inkjet printing system 20 along an electronic, infrared, optical, or other information transfer path. Data 39 represents, for example, a document and/or file to be printed. As such, data 39 forms a print job for inkjet printing system 20 and includes one or more print job commands and/or command parameters.

In one embodiment, electronic controller 30 controls inkjet printhead assembly 22 for ejection of ink drops from nozzles 34. As such, electronic controller 30 defines a pattern of ejected ink drops that form characters, symbols, and/or other graphics or images on print medium 36. The pattern of ejected ink drops is determined by the print job commands and/or command parameters.

In one embodiment, inkjet printhead assembly 22 includes one printhead 40. In another embodiment, inkjet printhead assembly 22 is a wide-array or multi-head printhead assembly. In one wide-array embodiment, inkjet printhead assembly 22 includes a carrier, which carries printhead dies 40, provides electrical communication between printhead dies 40 and electronic controller 30, and provides fluidic communication between printhead dies 40 and ink supply assembly 24.

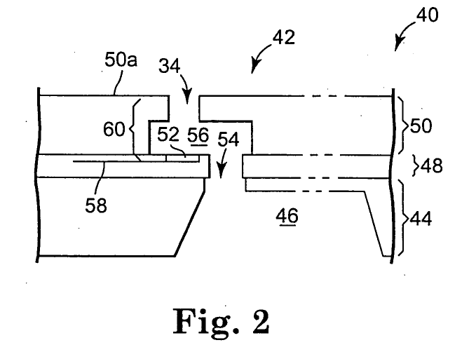

FIG. 2 is a diagram illustrating a portion of one embodiment of a printhead die 40. The printhead die 40 includes an array of printing or fluid ejecting elements 42. Printing elements 42 are formed on a substrate 44, which has an ink feed slot 46 formed therein. As such, ink feed slot 46 provides a supply of liquid ink to printing elements 42. Ink feed slot 46 is one embodiment of a fluid feed source. Other embodiments of fluid feed sources include but are not limited to corresponding individual ink feed holes feeding corresponding vaporization chambers and multiple shorter ink feed trenches that each feed corresponding groups of fluid ejecting elements. A thin-film structure 48 has an ink feed channel 54 formed therein which communicates with ink feed slot 46 formed in substrate 44. An orifice layer 50 has a front face 50a and a nozzle opening 34 formed in front face 50a. Orifice layer 50 also has a nozzle chamber or vaporization chamber 56 formed therein which communicates with nozzle opening 34 and ink feed channel 54 of thin-film structure 48. A firing resistor 52 is positioned within vaporization chamber 56 and leads 58 electrically couple firing resistor 52 to circuitry controlling the application of electrical current through selected firing resistors. A drop generator 60 as referred to herein includes firing resistor 52, nozzle chamber or vaporization chamber 56 and nozzle opening 34.

During printing, ink flows from ink feed slot 46 to vaporization chamber 56 via ink feed channel 54. Nozzle opening 34 is operatively associated with firing resistor 52 such that droplets of ink within vaporization chamber 56 are ejected through nozzle opening 34 (e.g., substantially normal to the plane of firing resistor 52) and toward print medium 36 upon energizing of firing resistor 52.

Example embodiments of printhead dies 40 include a thermal printhead, a piezoelectric printhead, an electrostatic printhead, or any other type of fluid ejection device known in the art that can be integrated into a multi-layer structure. Substrate 44 is formed, for example, of silicon, glass, ceramic, or a stable polymer and thin-film structure 48 is formed to include one or more passivation or insulation layers of silicon dioxide, silicon carbide, silicon nitride, tantalum, polysilicon glass, or other suitable material. Thin-film structure 48, also, includes at least one conductive layer, which defines firing resistor 52 and leads 58. In one embodiment, the conductive layer comprises, for example, aluminum, gold, tantalum, tantalum-aluminum, or other metal or metal alloy. In one embodiment, firing cell circuitry, such as described in detail below, is implemented in substrate and thin-film layers, such as substrate 44 and thin-film structure 48.

In one embodiment, orifice layer 50 comprises a photoimageable epoxy resin, for example, an epoxy referred to as SU8, marketed by Micro-Chem, Newton, Mass. Exemplary techniques for fabricating orifice layer 50 with SU8 or other polymers are described in detail in U.S. Pat. No. 6,162,589, which is herein incorporated by reference. In one embodiment, orifice layer 50 is formed of two separate layers referred to as a barrier layer (e.g., a dry film photo resist barrier layer) and a metal orifice layer (e.g., a nickel, copper, iron/nickel alloys, palladium, gold, or rhodium layer) formed over the barrier layer. Other suitable materials, however, can be employed to form orifice layer 50.

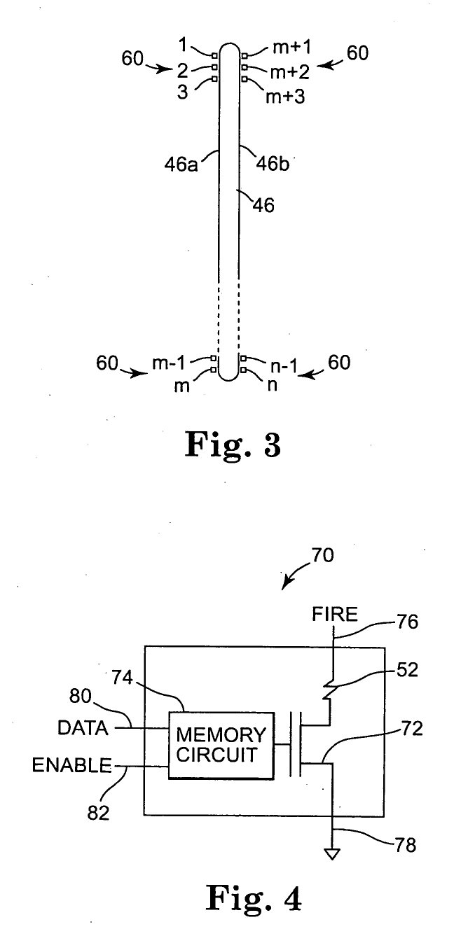

FIG. 3 is a diagram illustrating drop generators 60 located along ink feed slot 46 in one embodiment of printhead die 40. Ink feed slot 46 includes opposing ink feed slot sides 46a and 46b. Drop generators 60 are disposed along each of the opposing ink feed slot sides 46a and 46b. A total of n drop generators 60 are located along ink feed slot 46, with m drop generators 60 located along ink feed slot side 46a, and n-m drop generators 60 located along ink feed slot side 46b. In one embodiment, n equals 200 drop generators 60 located along ink feed slot 46 and m equals 100 drop generators 60 located along each of the opposing ink feed slot sides 46a and 46b. In other embodiments, any suitable number of drop generators 60 can be disposed along ink feed slot 46.

Ink feed slot 46 provides ink to each of the n drop generators 60 disposed along ink feed slot 46. Each of the n drop generators 60 includes a firing resistor 52, a vaporization chamber 56 and a nozzle 34. Each of the n vaporization chambers 56 is fluidically coupled to ink feed slot 46 through at least one ink feed channel 54. The firing resistors 52 of drop generators 60 are energized in a controlled sequence to eject fluid from vaporization chambers 56 and through nozzles 34 to print an image on print medium 36.

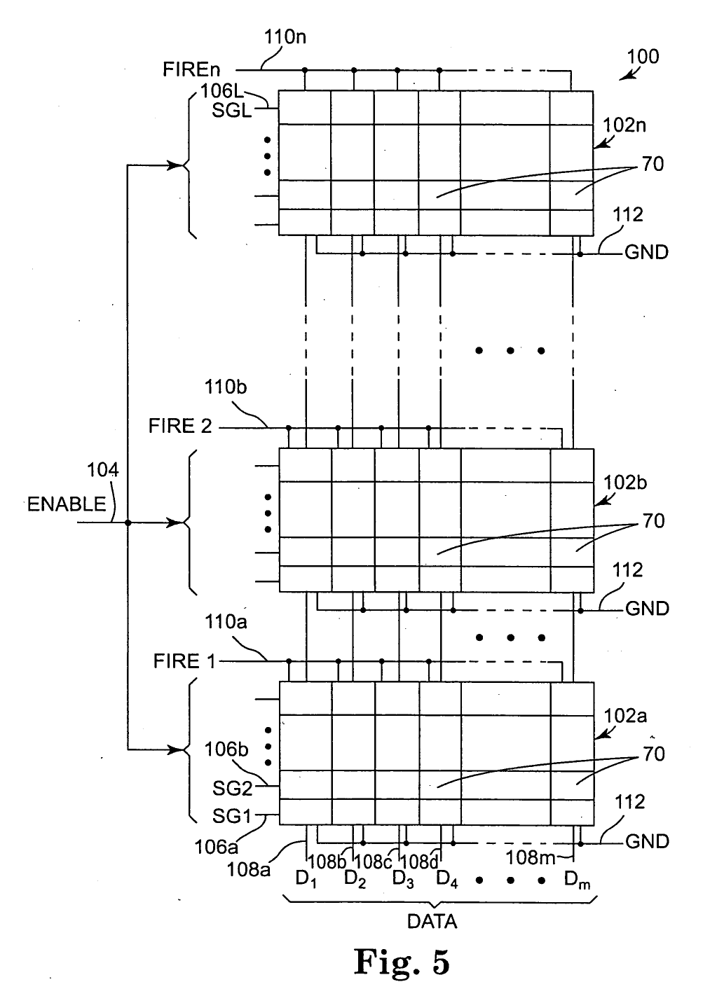

FIG. 4 is a diagram illustrating one embodiment of a firing cell 70 employed in one embodiment of printhead die 40. Firing cell 70 includes a firing resistor 52, a resistor drive switch 72, and a memory circuit 74. Firing resistor 52 is part of a drop generator 60. Drive switch 72 and memory circuit 74 are part of the circuitry that controls the application of electrical current through firing resistor 52. Firing cell 70 is formed in thin-film structure 48 and on substrate 44.

In one embodiment, firing resistor 52 is a thin-film resistor and drive switch 72 is a field effect transistor (FET). Firing resistor 52 is electrically coupled to a fire line 76 and the drain-source path of drive switch 72. The drain-source path of drive switch 72 is also electrically coupled to a reference line 78 that is coupled to a reference voltage, such as ground. The gate of drive switch 72 is electrically coupled to memory circuit 74 that controls the state of drive switch 72.

Memory circuit 74 is electrically coupled to a data line 80 and enable lines 82. Data line 80 receives a data signal that represents part of an image and enable lines 82 receive enable signals to control operation of memory circuit 74. Memory circuit 74 stores one bit of data as it is enabled by the enable signals. The logic level of the stored data bit sets the state (e.g., on or off, conducting or non-conducting) of drive switch 72. The enable signals can include one or more select signals and one or more address signals.

Fire line 76 receives an energy signal comprising energy pulses and provides an energy pulse to firing resistor 52. In one embodiment, the energy pulses are provided by electronic controller 30 to have timed starting times and timed duration to provide a proper amount of energy to heat and vaporize fluid in the vaporization chamber 56 of a drop generator 60. If drive switch 72 is on (conducting), the energy pulse heats firing resistor 52 to heat and eject fluid from drop generator 60. If drive switch 72 is off (non-conducting), the energy pulse does not heat firing resistor 52 and the fluid remains in drop generator 60.

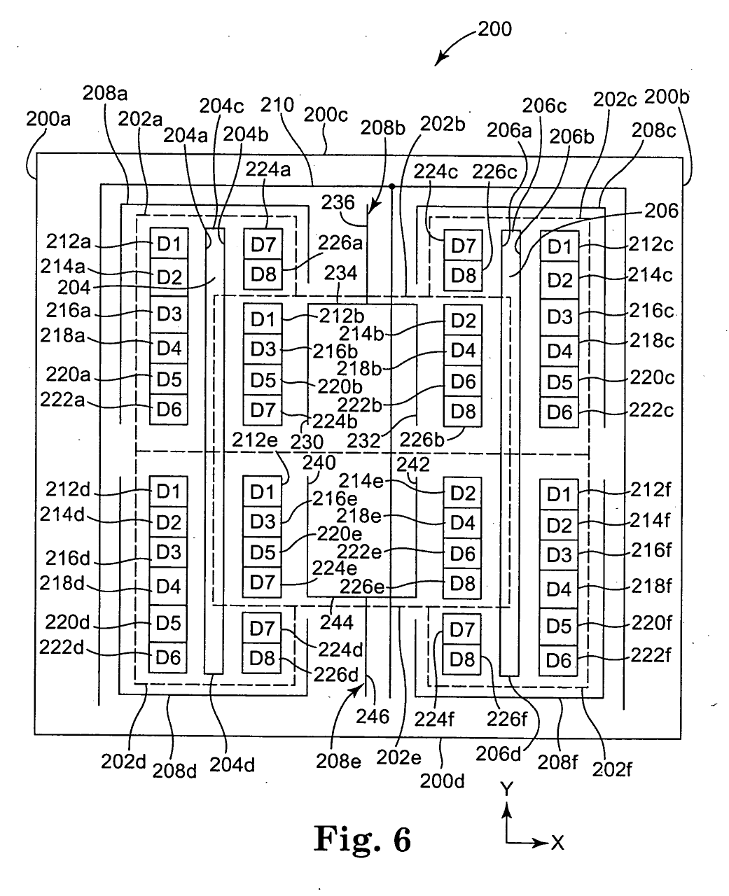

FIG. 5 is a schematic diagram illustrating one embodiment of an inkjet printhead firing cell array, indicated at 100. Firing cell array 100 includes a plurality of firing cells 70 arranged into n fire groups 102a-102n. In one embodiment, firing cells 70 are arranged into six fire groups 102a-102n. In other embodiments, firing cells 70 can be arranged into any suitable number of fire groups 102a-102n, such as four or more fire groups 102a-102n.

The firing cells 70 in array 100 are schematically arranged into L rows and m columns. The L rows of firing cells 70 are electrically coupled to enable lines 104 that receive enable signals. Each row of firing cells 70, referred to herein as a row subgroup or subgroup of firing cells 70, is electrically coupled to one set of subgroup enable lines 106a-106L. The subgroup enable lines 106a-106L receive subgroup enable signals SG1, SG2, . . . SG_{L} that enable the corresponding subgroup of firing cells 70.

The m columns are electrically coupled to m data lines 108a-108m that receive data signals D1, D2 . . . Dm, respectively. Each of the m columns includes firing cells 70 in each of the n fire groups 102a-102n and each column of firing cells 70, referred to herein as a data line group or data group, is electrically coupled to one of the data lines 108a-108m. In other words, each of the data lines 108a-108m is electrically coupled to each of the firing cells 70 in one column, including firing cells 70 in each of the fire groups 102a-102n. For example, data line 108a is electrically coupled to each of the firing cells 70 in the far left column, including firing cells 70 in each of the fire groups 102a-102n. Data line 108b is electrically coupled to each of the firing cells 70 in the adjacent column and so on, over to and including data line 108m that is electrically coupled to each of the firing cells 70 in the far right column, including firing cells 70 in each of the fire groups 102a-102n.

In one embodiment, array 100 is arranged into six fire groups 102a-102n and each of the six fire groups 102a-102n include 13 subgroups and eight data line groups. In other embodiments, array 100 can be arranged into any suitable number of fire groups 102a-102n and into any suitable number of subgroups and data line groups. In any embodiment, fire groups 102a-102n are not limited to having the same number of subgroups and data line groups. Instead, each of the fire groups 102a-102n can have a different number of subgroups and/or data line groups as compared to any other fire group 102a-102n. In addition, each subgroup can have a different number of firing cells 70 as compared to any other subgroup, and each data line group can have a different number of firing cells 70 as compared to any other data line group.

The firing cells 70 in each of the fire groups 102a-102n are electrically coupled to one of the fire lines 110a-110n. In fire group 102a, each of the firing cells 70 is electrically coupled to fire line 110a that receives fire signal or energy signal FIRE1. In fire group 102b, each of the firing cells 70 is electrically coupled to fire line 110b that receives fire signal or energy signal FIRE2 and so on, up to and including fire group 102n wherein each of the firing cells 70 is electrically coupled to fire line 110n that receives fire signal or energy signal FIREn. In addition, each of the firing cells 70 in each of the fire groups 102a-102n is electrically coupled to a common reference line 112 that is tied to ground.

In operation, subgroup enable signals SG1, SG2, . . . SG_{L} are provided on subgroup enable lines 106a-106L to enable one subgroup of firing cells 70. The enabled firing cells 70 store data signals D1, D2 . . . Dm provided on data lines 108a-108m. The data signals D1, D2 . . . Dm are stored in memory circuits 74 of enabled firing cells 70. Each of the stored data signals D1, D2 . . . Dm sets the state of drive switch 72 in one of the enabled firing cells 70. The drive switch 72 is set to conduct or not conduct based on the stored data signal value.

After the states of the selected drive switches 72 are set, an energy signal FIRE1-FIREn is provided on the fire line 110a-110n corresponding to the fire group 102a-102n that includes the selected subgroup of firing cells 70. The energy signal FIRE1-FIREn includes an energy pulse. The energy pulse is provided on the selected fire line 110a-110n to energize firing resistors 52 in firing cells 70 that have conducting drive switches 72. The energized firing resistors 52 heat and eject ink onto print medium 36 to print an image represented by data signals D1, D2 . . . Dm. The process of enabling a subgroup of firing cells 70, storing data signals D1, D2 . . . Dm in the enabled subgroup and providing an energy signal FIRE1-FIREn to energize firing resistors 52 in the enabled subgroup continues until printing stops.

In one embodiment, as an energy signal FIRE1-FIREn is provided to a selected fire group 102a-102n, subgroup enable signals SG1, SG2, . . . SG_{L} change to select and enable another subgroup in a different fire group 102a-102n. The newly enabled subgroup stores data signals D1, D2 . . . Dm provided on data lines 108a-108m and an energy signal FIRE1-FIREn is provided on one of the fire lines 110a-110n to energize firing resistors 52 in the newly enabled firing cells 70. At any one time, only one subgroup of firing cells 70 is enabled by subgroup enable signals SG1, SG2, . . . SG_{L} to store data signals D1, D2 . . . Dm provided on data lines 108a-108m. In this aspect, data signals D1, D2 . . . Dm on data lines 108a-108m are timed division multiplexed data signals. Also, only one subgroup in a selected fire group 102a-102n includes drive switches 72 that are set to conduct while an energy signal FIRE1-FIREn is provided to the selected fire group 102a-102n. However, energy signals FIRE1-FIREn provided to different fire groups 102a-102n can and do overlap.

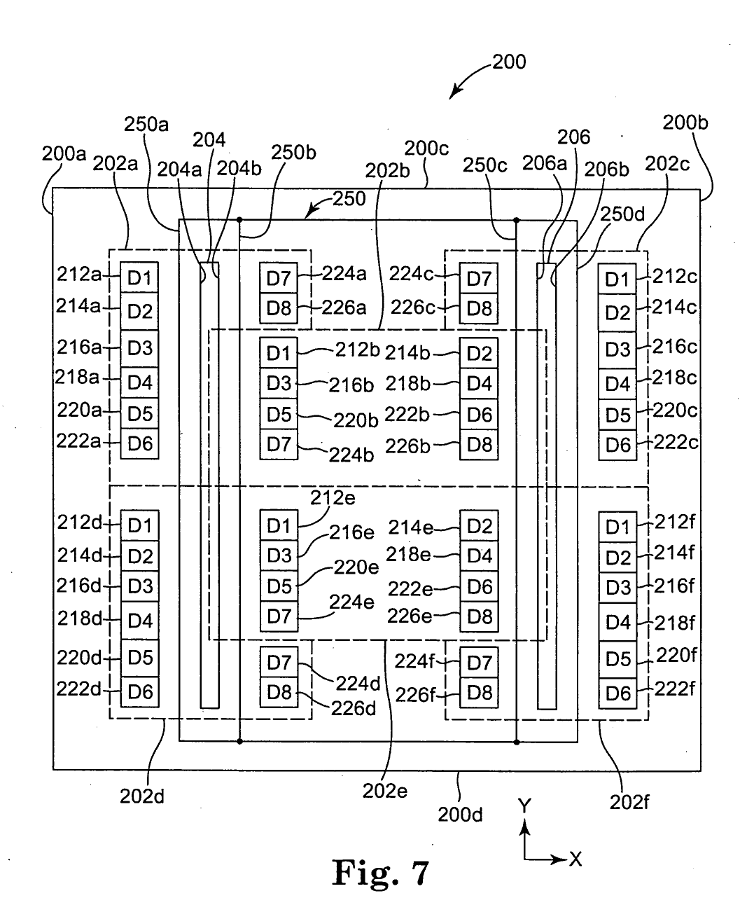

FIG. 6 is a block diagram illustrating one embodiment of a layout of printhead die 200. The printhead die 200 includes six fire groups 202a-202f, two ink feed slots 204 and 206, six fire lines 208a-208f and enable lines 210. The fire lines 208a-208f correspond to fire groups 202a-202f, respectively. The enable lines 210 provide subgroup enable signals SG1, SG2, . . . SG_{L} to fire groups 202a-202f to enable selected row subgroups.

The six fire groups 202a-202f are disposed along ink feed slots 204 and 206. Fire groups 202a and 202d are disposed along ink feed slot 204, and fire groups 202c and 202f are disposed along ink feed slot 206. The fire groups 202b and 202e are disposed along both ink feed slots 204 and 206. The ink feed slots 204 and 206 are located parallel to one another and each ink feed slot 204 and 206 includes a length that extends along the y-direction of printhead die 200. In one embodiment, ink feed slots 204 and 206 supply the same color ink, such as black, yellow, magenta or cyan colored ink, to drop generators 60 in fire groups 202a-202f. In other embodiments, each of the ink feed slots 204 and 206 supplies a different color ink to the drop generators 60.

The fire groups 202a-202f are divided into eight data line groups, indicated at D1-D8. Each data line group D1-D8 includes firing cells 70 from each of the six fire groups 202a-202f. Each of the firing cells 70 in a data line group D1-D8 is electrically coupled to a corresponding one of the eight data lines 108a-108h (FIG. 5). Data line group D1, indicated at 212a-212f, includes firing cells 70 electrically coupled to data line 108a. Data line group D2, indicated at 214a-214f, includes firing cells 70 electrically coupled to data line 108b. Data line group D3, indicated at 216a-216f, includes firing cells 70 electrically coupled to data line 108c. Data line group D4, indicated at 218a-218f, includes firing cells 70 electrically coupled to data line 108d. Data line group D5, indicated at 220a-220f, includes firing cells 70 electrically coupled to data line 108e. Data line group D6, indicated at 222a-222f, includes firing cells 70 electrically coupled to data line 108f. Data line group D7, indicated at 224a-224f, includes firing cells 70 electrically coupled to data line 108g, and data line group D8, indicated at 226a-226f, includes firing cells 70 electrically coupled to data line 108h. Each of the firing cells 70 in printhead die 200 is electrically coupled to only one data line 108a-108h, and each data line 108a-108h is electrically coupled to all memory circuits 74 in firing cells 70 of the corresponding data line group D1-D8.

Fire group 1 (FG1) 202a is disposed along a first part of ink feed slot 204. The ink feed slot 204 includes opposing ink feed slot sides 204a and 204b that extend along the y-direction of printhead die 200. The firing cells 70 in printhead die 200 include firing resistors 52 that are part of drop generators 60. The drop generators 60 in FG1 at 202a are disposed along each of the opposing sides 204a and 204b of ink feed slot 204. The drop generators 60 in FG1 at 202a are fluidically coupled to ink feed slot 204 to receive ink from ink feed slot 204.

Drop generators 60 in data line groups D1-D6, indicated at 212a, 214a , 216a, 218a, 220a and 222a in FG1 at 202a are disposed along one side 204a of ink feed slot 204. Drop generators 60 in data line groups D7 and D8, indicated at 224a and 226a, are disposed along the opposing side 204b of ink feed slot 204. The drop generators 60 in data line groups D1-D6 at 212a, 214a , 216a, 218a, 220a and 222a are disposed between one side 200a of printhead die 200 and ink feed slot 204. The drop generators 60 in data line groups D7 and D8 at 224a and 226a are disposed along an inside channel of printhead die 200 between ink feed slot 204 and ink feed slot 206.

In one embodiment, drop generators 60 in data line groups D1-D6 at 212a, 214a , 216a, 218a, 220a and 222a are located along the length of side 204a of ink feed slot 204, such that data line group D1 at 212a is next to data line group D2 at 214a , which is between data line D1 at 212a and data line group D3 at 216a. Data line group D4 at 218a is between data line group D3 at 216a and data line group D5 at 220a. Data line group D6 at 222a is next to data line group D5 at 220a. Drop generators 60 in data line groups D7 and D8 at 224a and 226a are located along the opposing side 204b of ink feed slot 204, such that data line group D1 at 212a is opposite data line group D7 at 224a and data line group D2 at 214a is opposite data line group D8 at 226a.

Fire group 4 (FG4) 202d is disposed along a second part of ink feed slot 204. The drop generators 60 in FG4 at 202d are disposed along each of the opposing sides 204a and 204b of ink feed slot 204 and fluidically coupled to ink feed slot 204 to receive ink from ink feed slot 204. Drop generators 60 in data line groups D1-D6, indicated at 212d, 214d, 216d, 218d, 220d and 222d are disposed along one side 204a of ink feed slot 204. Drop generators 60 in data line groups D7 and D8, indicated at 224d and 226d, are disposed along the opposing side 204b of ink feed slot 204. The drop generators 60 in data line groups D1-D6 at 212d, 214d, 216d, 218d, 220d and 222d are disposed between one side 200a of printhead die 200 and ink feed slot 204. Drop generators 60 in data line groups D7 and D8 at 224d and 226d are disposed along an inside channel of printhead die 200 between ink feed slot 204 and ink feed slot 206.

In one embodiment, drop generators 60 in data line groups D1-D6 at 212d, 214d, 216d, 218d, 220d and 222d are located along the length of one side 204a of ink feed slot 204, such that data line group D1 at 212d is next to data line group D2 at 214d, which is between data line group D1 at 212d and data line group D3 at 216d. Data line group D4 at 218d is between data line group D3 at 216d and data line group D5 at 220d. Data line group D6 at 222d is next to data line group D5 at 220d. Drop generators 60 in data line groups D7 and D8 at 224d and 226d are located along the opposing side 204b of ink feed slot 204, such that data line group D5 at 220d is opposite data line group D7 at 224d and data line group D6 at 222d is opposite data line group D8 at 226d.

Fire group 3 (FG3) 202c is disposed along a first part of ink feed slot 206. The ink feed slot 206 includes opposing ink feed slot sides 206a and 206b that extend along the y-direction of printhead die 200. The firing cells 70 in printhead die 200 include firing resistors 52 that are part of drop generators 60. The drop generators 60 in FG3 at 202c are disposed along each of the opposing sides 206a and 206b of ink feed slot 206. The drop generators 60 in FG3 at 202c are fluidically coupled to ink feed slot 206 to receive ink from ink feed slot 206.

Drop generators 60 in data line groups D1-D6, indicated at 212c, 214c, 216c, 218c, 220c and 222c in FG3 at 202c are disposed along one side 206b of ink feed slot 206. Drop generators 60 in data line groups D7 and D8, indicated at 224c and 226c, are disposed along the opposing side 206a of ink feed slot 206. The drop generators 60 in data line groups D1-D6 at 212c, 214c, 216c, 218c, 220c and 222c are disposed between one side 200b of printhead die 200 and ink feed slot 206. The drop generators 60 in data line groups D7 and D8 at 224c and 226c are disposed along an inside channel of printhead die 200 between ink feed slot 204 and ink feed slot 206.

In one embodiment, drop generators 60 in data line groups D1-D6 at 212c, 214c, 216c, 218c, 220c and 222c are located along the length of side 206b of ink feed slot 206, such that data line group D1 at 212c is next to data line group D2 at 214c, which is between data line D1 at 212c and data line group D3 at 216c. Data line group D4 at 218c is between data line group D3 at 216c and data line group D5 at 220c. Data line group D6 at 222c is next to data line group D5 at 220c. Drop generators 60 in data line groups D7 and D8 at 224c and 226c are located along the opposing side 206a of ink feed slot 206, such that data line group D1 at 212c is opposite data line group D7 at 224c and data line group D2 at 214c is opposite data line group D8 at 226c.

Fire group 6 (FG6) 202f is disposed along a second part of ink feed slot 206. The drop generators 60 in FG6 at 202f are disposed along each of the opposing sides 206a and 206b of ink feed slot 206 and fluidically coupled to ink feed slot 206 to receive ink from ink feed slot 206. Drop generators 60 in data line groups D1-D6, indicated at 212f, 214f, 216f, 218f, 220f and 222f are disposed along one side 206b of ink feed slot 206. Drop generators 60 in data line groups D7 and D8, indicated at 224f and 226f, are disposed along the opposing side 206a of ink feed slot 206. The drop generators 60 in data line groups D1-D6 at 212f, 214f, 216f, 218f, 220f and 222f are disposed between one side 200b of printhead die 200 and ink feed slot 206. Drop generators 60 in data line groups D7 and D8 at 224f and 226f are disposed along an inside channel of printhead die 200 between ink feed slot 204 and ink feed slot 206.

In one embodiment, drop generators 60 in data line groups D1-D6 at 212f, 214f, 216f, 218f, 220f and 222f are located along the length of one side 206b of ink feed slot 206, such that data line group D1 at 212f is next to data line group D2 at 214f, which is between data line group D1 at 212f and data line group D3 at 216f. Data line group D4 at 218f is between data line group D3 at 216f and data line group D5 at 220f. Data line group D6 at 222f is next to data line group D5 at 220f. Drop generators 60 in data line groups D7 and D8 at 224f and 226f are located along the opposing side 206a of ink feed slot 206, such that data line group D5 at 220f is opposite data line group D7 at 224f and data line group D6 at 222f is opposite data line group D8 at 226f.

Fire group 2 (FG2) 202b is disposed along the first parts of ink feed slots 204 and 206. The drop generators 60 in FG2 at 202b are disposed along side 204b of ink feed slot 204 and side 206a of ink feed slot 206. Drop generators 60 in data line groups D1, D3, D5 and D7, indicated at 212b, 216b, 220b and 224b are disposed along side 204b of ink feed slot 204 and fluidically coupled to ink feed slot 204 to receive ink from ink feed slot 204. Drop generators 60 in data line groups D2, D4, D6 and D8, indicated at 214b, 218b, 222b and 226b are disposed along side 206a of ink feed slot 206 to receive ink from ink feed slot 206. The drop generators 60 in FG2 at 202b are disposed between ink feed slots 204 and 206.

In one embodiment, drop generators 60 in data line groups D1, D3, D5 and D7 at 212b, 216b, 220b and 224b are located along the length of side 204b of ink feed slot 204 and drop generators 60 in data line groups D2, D4, D6 and D8 at 214b, 218b, 222b and 226b are located along the length of side 206a of ink feed slot 206. Data line group D1 at 212b in FG2 at 202b on side 204b of ink feed slot 204 is across from or opposite data line group D3 at 216a in FG1 at 202a along side 204a. Data line group D3 at 216b in FG2 at 202b is opposite data line group D4 at 218a in FG1 at 202a. Data line group D5 at 220b in FG2 at 202b is opposite data line group D5 at 220a in FG1 at 202a. Data line group D7 at 224b in FG2 at 202b is opposite data line group D6 at 222a in FG1 at 202a.

Along ink feed slot 206, data line group D2 at 214b in FG2 at 202b is along side 206a of ink feed slot 206 and across from or opposite data line group D3 at 216c in FG3 at 202c along side 206b. Data line group D4 at 218b in FG2 at 202b is opposite data line group D4 at 218c in FG3 at 202c. Data line group D6 at 222b in FG2 at 202b is opposite data line group D5 at 220c in FG3 at 202c, and data line group D8 at 226b in FG2 at 202b is opposite data line group D6 at 222c in FG3 at 202c.

Fire group 5 (FG5) 202e is disposed along the second parts of ink feed slots 204 and 206. The drop generators 60 in FG5 at 202e are disposed along side 204b of ink feed slot 204 and side 206a of ink feed slot 206. Drop generators 60 in data line groups D1, D3, D5 and D7, indicated at 212e, 216e, 220e and 224e are disposed along side 204b of ink feed slot 204 and fluidically coupled to ink feed slot 204 to receive ink from ink feed slot 204. Drop generators 60 in data line groups D2, D4, D6 and D8, indicated at 214e, 218e, 222e and 226e are disposed along side 206a of ink feed slot 206 to receive ink from ink feed slot 206. The drop generators 60 in FG5 at 202e are disposed between ink feed slots 204 and 206.

In one embodiment, drop generators 60 in data line groups D1, D3, D5 and D7 at 212e, 216e, 220e and 224e are located along the length of side 204b of ink feed slot 204 and drop generators 60 in data line groups D2, D4, D6 and D8 at 214e, 218e, 222e and 226e are located along the length of side 206a of ink feed slot 206. Data line group D1 at 212e in FG5 at 202e on side 204b of ink feed slot 204 is across from or opposite data line group D1 at 212d in FG4 at 202d along side 204a. Data line group D3 at 216e in FG5 at 202e is opposite data line group D2 at 214d in FG4 at 202d. Data line group D5 at 220e in FG5 at 202e is opposite data line group D3 at 216d in FG4 at 202d. Data line group D7 at 224e in FG5 at 202e is opposite data line group D4 at 218d in FG4 at 202d.

Along ink feed slot 206, data line group D2 at 214e in FG5 at 202e is along side 206a of ink feed slot 206 and across from or opposite data line group D1 at 212f in FG6 at 202f along side 206b. Data line group D4 at 218e in FG5 at 202e is opposite data line group D2 at 214f in FG6 at 202f. Data line group D6 at 222e in FG5 at 202e is opposite data line group D3 at 216f in FG6 at 202f, and data line group D8 at 226e in FG5 at 202e is opposite data line group D4 at 218f in FG6 at 202f.

In one embodiment, printhead die 200 includes 672 drop generators 60. Each of the six fire groups 202a-202f includes 112 drop generators 60. Each part of a data line group D1-D8 at 212, 214, 216, 218, 220, 222, 224 and 226 in a fire group 202a-202f includes 14 drop generators 60, such that each fire group 202a-202f includes 14 row subgroups coupled to 8 data lines 108a-108h. In other embodiments, printhead die 200 can include any suitable number of drop generators 60, such as 600 drop generators 60, arranged in any suitable pattern of drop generators per fire group and drop generators per data line group or part of a data line group. In addition, printhead die 200 can include any suitable number of fire groups and any suitable number of data line groups.

The conductive fire lines 208a-208f are electrically coupled to firing resistors 52 in drop generators 60 in fire groups 202a-202f. Fire line 208a is electrically coupled to each firing resistor 52 in FG1 at 202a. Fire line 208a is disposed between one side 200a of printhead die 200 and ink feed slot 204 and between ink feed slots 204 and 206. Fire line 208a is coupled at one end 204c of ink feed slot 204 to form a substantially J-shaped or substantially U-shaped fire line. The portion of fire line 208a disposed between side 200a and ink feed slot 204 is electrically coupled to firing resistors 52 in data line groups D1-D6 at 212a, 214a, 216a, 218a, 220a and 222a. The portion of fire line 208a disposed between ink feed slot 204 and ink feed slot 206 is electrically coupled to firing resistors 52 in data line groups D7 and D8 at 224a and 226a. Fire line 208a receives and supplies energy signal FIRE1 including energy pulses to firing resistors 52 in FG1 at 202a.

Fire line 208d is electrically coupled to each firing resistor 52 in FG4 at 202d. Fire line 208d is disposed between one side 200a of printhead die 200 and ink feed slot 204 and between ink feed slots 204 and 206. Fire line 208d is coupled at one end 204d of ink feed slot 204 to form a substantially J-shaped or partial substantially U-shaped fire line. The portion of fire line 208d disposed between side 200a and ink feed slot 204 is electrically coupled to firing resistors 52 in data line groups D1-D6 at 212d, 214d, 216d, 218d, 220d and 222d. The portion of fire line 208d disposed between ink feed slot 204 and ink feed slot 206 is electrically coupled to firing resistors 52 in data line groups D7 and D8 at 224d and 226d. Fire line 208d receives and supplies energy signal FIRE4 including energy pulses to firing resistors 52 in FG4 at 202d.

Fire line 208c is electrically coupled to each firing resistor 52 in FG3 at 202c. Fire line 208c is disposed between one side 200b of printhead die 200 and ink feed slot 206 and between ink feed slots 204 and 206. Fire line 208c is coupled at one end 206c of ink feed slot 206 to form a substantially J-shaped or partial substantially u-shaped fire line. The portion of fire line 208c disposed between side 200b and ink feed slot 206 is electrically coupled to firing resistors 52 in data line groups D1-D6 at 212c, 214c, 216c, 218c, 220c and 222c. The portion of fire line 208c disposed between ink feed slot 204 and ink feed slot 206 is electrically coupled to firing resistors 52 in data line groups D7 and D8 at 224c and 226c. Fire line 208c receives and supplies energy signal FIRE3 including energy pulses to firing resistors 52 in FG3 at 202c.

Fire line 208f is electrically coupled to each firing resistor 52 in FG6 at 202f. Fire line 208f is disposed between one side 200b of printhead die 200 and ink feed slot 206 and between ink feed slots 204 and 206. Fire line 208f is coupled at one end 206d of ink feed slot 206 to form a substantially J-shaped or partial substantially U-shaped fire line. The portion of fire line 208f disposed between side 200b and ink feed slot 206 is electrically coupled to firing resistors 52 in data line groups D1-D6 at 212f, 214f, 216f, 218f, 220f and 222f. The portion of fire line 208f disposed between ink feed slot 204 and ink feed slot 206 is electrically coupled to firing resistors 52 in data line groups D7 and D8 at 224f and 226f. Fire line 208f receives and supplies energy signal FIRE6 including energy pulses to firing resistors 52 in FG6 at 202f.

Fire line 208b is electrically coupled to each firing resistor 52 in FG2 at 202b. Fire line 208b is disposed between ink feed slots 204 and 206. One section 230 of fire line 208b is located across firing cells 70 in data line groups D1, D3, D5 and D7 at 212b, 216b, 220b and 224b next to ink feed slot 204 and another section 232 of fire line 208b is located across firing cells 70 in data line groups D2, D4, D6 and D8 at 214b, 218b, 222b and 226b next to ink feed slot 206. The sections 230 and 232 are electrically coupled together at 234 between ink feed slots 204 and 206 and a third section or post section 236 of fire line 208b is electrically coupled to the first and second sections 230 and 232 and extends toward side 200c of printhead die 200. Fire line 208b receives and supplies energy signal FIRE2 including energy pulses to firing resistors 52 in FG2 at 202b.

Fire line 208e is electrically coupled to each firing resistor 52 in FG5 at 202e. Fire line 208e is disposed between ink feed slots 204 and 206. One section 240 of fire line 208e is located across firing cells 70 in data line groups D1, D3, D5 and D7 at 212e, 216e, 220e and 224e next to ink feed slot 204 and another section 242 of fire line 208e is located across firing cells 70 in data line groups D2, D4, D6 and D8 at 214e, 218e, 222e and 226e next to ink feed slot 206. The sections 240 and 242 are electrically coupled together at 244 between ink feed slots 204 and 206 and a third section or post section 246 of fire line 208e is electrically coupled to first and second sections 240 and 242 and extends toward side 200d of printhead die 200. Fire line 208e receives and supplies energy signal FIRE5 including energy pulses to firing resistors 52 in FG5 at 202e.

Enable lines 210 are electrically coupled to firing cells 70 in row subgroups in fire groups 202a-202f. The enable lines 210 are electrically coupled to firing cells 70 in row subgroups as previously described for enable lines 106a-106L. Enable lines 210 receive subgroup enable signals SG1, SG2, . . . SG_{L} and provide the received signals to firing cells 70 in row subgroups. The subgroup enable signals SG1, SG2, . . . SG_{L} enable one row subgroup of firing cells 70 to receive and store data signals D1-D8 provided on data lines 108a-108h.

The enable lines 210 are located between ink feed slot 204 and printhead die side 200a and between ink feed slot 206 and printhead die side 200b. In addition, enable lines 210 are routed between ink feed slots 204 and 206. The enable lines 210 extend along one side 200c of printhead die 200. In one embodiment, some of the enable lines 210 are divided into two groups of enable lines. One group provides enable signals to fire groups 202a-202c and another group provides enable signals to fire groups 202d-202f.

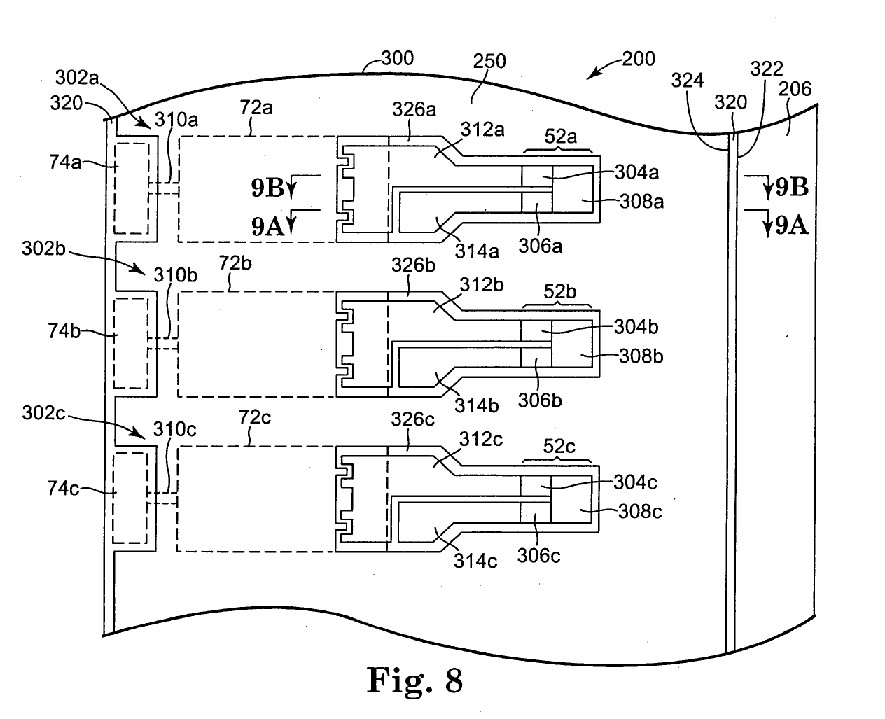

FIG. 7 is a block diagram illustrating one embodiment of a layout of a reference conductor 250 in printhead die 200. The printhead die 200 includes the six fire groups 202a-202f, two ink feed slots 204 and 206 and reference conductor 250. The reference conductor 250 is electrically coupled to each of the firing cells 70 in each of the fire groups 202a-202f. The drain-source path of each drive switch 72 in each of the firing cells 70 is electrically coupled to reference conductor 250. In addition, reference conductor 250 is electrically coupled to a reference voltage, such as ground. In one embodiment, reference conductor 250 is coupled through external contacts to external circuitry or ground paths. (See, FIG. 15).

The fire groups 202a-202f are disposed along ink feed slots 204 and 206. Fire groups 202a and 202d are located along ink feed slot 204, and fire groups 202c and 202f are located along ink feed slot 206. Fire groups 202b and 202e are located along both ink feed slots 204 and 206.

The fire groups 202a-202f are divided into eight data line groups D1-D8, indicated at 212, 214, 216, 218, 220, 222, 224 and 226. Each data line group D1-D8 at 212, 214, 216, 218,220, 222, 224 and 226 includes firing cells 70 from each fire group 202a-202f. Each firing cell 70 in a data line group D1-D8 at 212, 214, 216, 218, 220, 222, 224 and 226 is electrically coupled to the corresponding one of eight data lines 108a-108h. The fire groups 202a-202f and data line groups D1-D8 at 212, 214, 216, 218, 220, 222, 224 and 226 are disposed along ink feed slots 204 and 206 as previously described in detail herein.

The ink feed slots 204 and 206 are spaced apart and parallel to one another. Each ink feed slot 204 and 206 includes a length that extends along the y-direction of printhead die 200. Ink feed slot 204 includes opposing sides 204a and 204b along the length of ink feed slot 204, and ink feed slot 206 includes opposing sides 206a and 206b along the length of ink feed slot 206. The ink feed slots 204 and 206 supply ink to drop generators 60 in fire groups 202a-202f.

The reference conductor 250 includes a first portion 250a, a second portion 250b, a third portion 250c and a fourth portion 250d electrically coupled together at each end of ink feed slots 204 and 206. The reference conductor 250 is disposed along each of the opposing sides 204a and 204b of ink feed slot 204, and along each of the opposing sides 206a and 206b of ink feed slot 206. The portions 250a-250d are electrically coupled together along side 200c of printhead die 200 and along side 200d of printhead die 200.

The first portion 250a of reference conductor 250 is situated across each firing cell 70 in data line groups D1-D6 at 212a, 214a, 216a, 218a, 220a and 222a in FG1 at 202a. The first portion 250a of reference conductor 250 is also situated across each firing cell 70 in data line groups D1-D6 at 212d, 214d, 216d, 218d, 220d and 222d in FG4 at 202d. The first portion 250a is positioned along side 204a of ink feed slot 204 and between ink feed slot 204 and side 200a of printhead die 200.

The second portion 250b of reference conductor 250 is situated across each firing cell 70 in data line groups D7 and D8 at 224a and 226a in FG1 at 202a, data line groups D1, D3, D5 and D7 at 212b, 216b, 220b and 224b in FG2 at 202b, data line groups D1, D3, D5 and D7 at 212e, 216e, 220e and 224e in FG5 at 202e and data line groups D7 and D8 at 224d and 226d in FG4 at 202d. The second portion 250b is situated along side 204b of ink feed slot 204 and between ink feed slots 204 and 206.

The third portion 250c of reference conductor 250 is situated across each firing cell 70 in data line groups D7 and D8 at 224c and 226c in FG3 at 202c, data line groups D2, D4, D6 and D8 at 214b, 218b, 222b and 226b in FG2 at 202b, data line groups D2, D4, D6, D8 at 214e, 218e, 222e and 226e in FG5 at 202e and data line groups D7 and D8 at 224f and 226f in FG6 at 202f. The third portion 250c is situated along side 206a of ink feed slot 206 and between ink feed slots 204 and 206.

The fourth portion 250d of reference conductor 250 is situated across each firing cell 70 in data line groups D1-D6 at 212c, 214c, 216c, 218c, 220c and 222c in FG3 at 202c and data line groups D1-D6 at 212f, 214f, 216f, 218f, 220f and 222f in FG6 at 202f. The fourth portion 250 is situated along side 206b of ink feed slot 206 and between ink feed slot 206 and side 200b of printhead die 200. The portions 250a-250d of reference conductor 250 are electrically coupled together along sides 200c and 200d of printhead die 200.

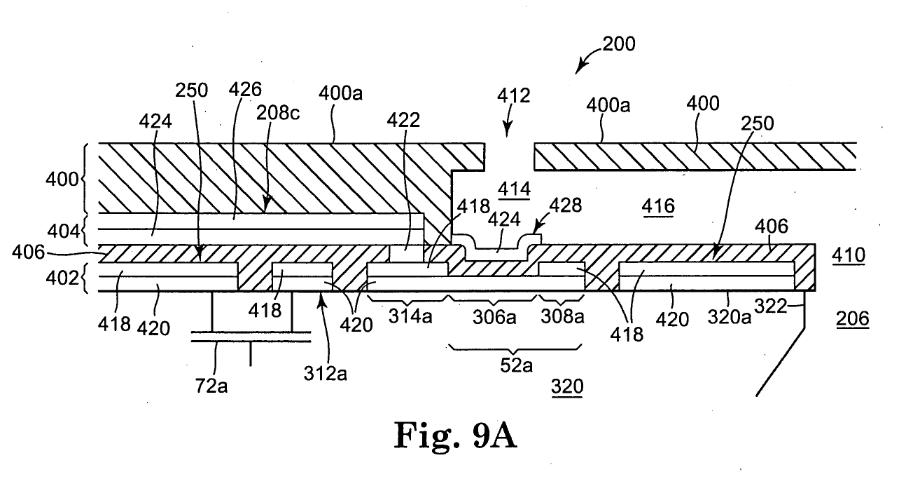

FIG. 8 is a plan view diagram illustrating one embodiment of a section 300 taken at the first metal layer of printhead die 200, depicting overlapping and non-overlapping regions from multiple layers. The actual structures described may be formed in one or more layers.

The section 300 includes three firing cells, indicated at 302a-302c, ink feed slot 206 and reference conductor 250. The three firing cells 302a-302c are similar to firing cells 70 throughout printhead die 200 and instances of firing cells 70 that are part of data line group D7 at 224c in FG3 at 202c. The firing cells 302a-302c include memory circuits 74a-74c, drive switches 72a-72c and firing resistors, indicated at 52a-52c.

The firing cell 302a includes memory circuit 74a, drive switch 72a and firing resistor 52a. The firing resistor 52a includes a first resistive segment 304a, a second resistive segment 306a and a conductive shorting bar 308a. The first resistive segment 304a and second resistive segment 306a are separate resistive segments electrically coupled together through conductive shorting bar 308a. The memory circuit 74a is electrically coupled to the gate of drive switch 72a through a substrate lead 310a. One side of the drain-source path of drive switch 72a is electrically coupled to reference conductor 250. The reference conductor 250 contacts drive switch 72a where the reference conductor 250 is disposed over, e.g. in a layer above, at least a portion of drive switch 72a. The other side of the drain-source path of drive switch 72a is electrically coupled to a drive switch conductive lead 312a that electrically couples the drain-source path of drive switch 72a to first resistive segment 304a. The second resistive segment 306a is electrically coupled to fire line 208c through fire line conductive lead 314a.

The firing cell 302b includes memory circuit 74b, drive switch 72b and firing resistor 52b. The firing resistor 52b includes a first resistive segment 304b, a second resistive segment 306b and a conductive shorting bar 308b. The first resistive segment 304b and second resistive segment 306b are separate resistive segments electrically coupled together through shorting bar 308b. The memory circuit 74b is electrically coupled to the gate of drive switch 72b through a substrate lead 310b. One side of the drain-source path of drive switch 72b is electrically coupled to reference conductor 250. The reference conductor 250 contacts drive switch 72b where the reference conductor 250 is disposed over a portion of drive switch 72b. The other side of the drain-source path of drive switch 72b is electrically coupled to a drive switch conductive lead 312b that electrically couples the drain-source path of drive switch 72b to first resistive segment 304b. The second resistive segment 306b is electrically coupled to fire line 208c through fire line conductive lead 314b.

The firing cell 302c includes memory circuit 74c, drive switch 72c and firing resistor 52c. The firing resistor 52c includes a first resistive segment 304c, a second resistive segment 306c and a conductive shorting bar 308c. The first resistive segment 304c and second resistive segment 306c are separate resistive segments electrically coupled together through shorting bar 308c. The memory circuit 74c is electrically coupled to the gate of drive switch 72c through a substrate lead 310c. The drain-source path of drive switch 72c is electrically coupled to reference conductor 250. The reference conductor 250 contacts the drive switch 72c where the reference conductor 250 is disposed over a portion of drive switch 72c. The other side of the drain-source path of drive switch 72c is electrically coupled to a drive switch conductive lead 312c that electrically couples the drain-source path of drive switch 72c to first resistive segment 304c. The second resistive segment 306c is electrically coupled to fire line 208c through fire line conductive lead 314c.

The firing cells 302a-302c are formed in and on semiconductor substrate 320 of printhead die 200. The memory circuits 74a-74c, drive switches 72a-72c and substrate leads 310a-310c are formed in substrate 320 of printhead die 200. The reference conductor 250, drive switch conductive leads 312a-312c, fire line conductive leads 314a-314c and shorting bars 308a-308c are formed as part of the first metal layer that is formed on substrate 320. In addition, first resistive segments 304a-304c and second resistive segments 306a-306c are formed as part of a resistive layer. In other embodiments, portions of reference conductor 250 may be formed in both first metal layer and second metal layer (not shown).

The ink feed slot 206 is formed in substrate 320 and provides ink to firing resistors 52a-52c. The ink feed slot 206 includes an ink feed slot edge 322 at the surface of substrate 320. The ink feed slot edge 322 is in communication with the surface of substrate 320 along the length of ink feed slot 206. The reference conductor 250, at 324 is disposed along ink feed slot 206 and spaced apart from ink feed slot edge 322. Opposing side 206a of ink feed slot 206 includes ink feed slot edge 322 and opposing side 206b of ink feed slot 206 includes an ink feed slot edge similar to ink feed slot edge 322. In addition, each of the opposing sides 204a and 204b of ink feed slot 204 includes an ink feed slot edge in communication with the surface of substrate 320 and similar to ink feed slot edge 322.

Portions of reference conductor 250 are formed in first metal layer, other portions may or may not be formed in second metal layer, and disposed between memory circuits 74a-74c and ink feed slot 206. The drive switch conductive leads 312a-312c, fire line conductive leads 314a-314c and firing resistors 52a-52c are isolated from reference conductor 250 and disposed in firing resistor areas 326a-326c. Firing resistor area 326a includes drive switch conductive lead 312a, fire line conductive lead 314a and firing resistor 52a. Firing resistor area 326b includes drive switch conductive lead 312b, fire line conductive lead 314b and firing resistor 52b. Firing resistor area 326c includes drive switch conductive lead 312c, fire line conductive lead 314c and firing resistor 52c.

The reference conductor 250 is disposed over a portion of each of the drive switches 72a-72c between memory circuits 74a-74c and firing resistor areas 326a-326c, including drive switch conductive leads 312a-312c. The reference conductor 250 is also disposed between ink feed slot edge 322 and firing resistor areas 326a-326c, including firing resistors 52a-52c. In addition, the reference conductor 250 is disposed between firing resistor areas 326a-326c of adjacent firing cells 302a-302c. The reference conductor 250 is substantially planar between memory circuits 74a-74c and ink feed slot edge 322. The reference conductor 250 has a larger or increased area due to the portion of reference conductor 250 that is disposed between ink feed slot edge 322 and firing resistor areas 326a-326c. The larger area reference conductor 250 reduces the energy variation between firing cells 70 and provides a more uniform ink pattern.

In the above described embodiment, the reference conductor 250 is disposed between ink feed slot edge 322 and firing resistor areas 326a-326c and is also disposed between and substantially planar with firing resistors areas 326a-326c of adjacent firing cells 302a-302c. In this embodiment, the reference conductor 250 is substantially planar with firing resistors 52a-52c but not the ink feed slot edge. In one embodiment, the ink feed slot edge is also planar with reference conductor 250. In one embodiment, the firing resistors 52a-52c are not substantially planar with reference conductor 250. Nevertheless, in all of these embodiments, the reference conductor is disposed between the ink feed slot edge and the firing resistors and is also disposed between the firing resistor areas of adjacent firing cells regardless of planar relationships.

In operation, one of the firing cells 302a-302c is fired or energized at a time. In one example operation, memory circuit 74a provides a voltage level on the gate of drive switch 72a to turn drive switch 72a on or off. Fire line 208c receives energy signal FIRE3 and provides an energy pulse to second resistive segment 306a through fire line conductive lead 314a.

If drive switch 72a is conducting, the energy pulse provides a current through firing resistor 52a, drive switch conductive lead 312a and drive switch 72a to reference conductor 250. With reference conductor 250 electrically coupled to a reference voltage, such as ground, the current flows through reference conductor 250 to ground.

As the current flows through reference conductor 250, the current flows between memory circuits 74a-74c and firing resistor areas 326a-326c, including drive switch conductive leads 312a-312c. The current also flows between adjacent firing resistor areas 326a-326c and between ink feed slot edge 322 and firing resistor areas 326a-326c, including firing resistors 52a-52c.

The layout of firing cells 302a-302c in section 300 is similar to the layout of firing cells 70 along ink feed slots 204 and 206 throughout printhead die 200. In addition, the layout of reference conductor 250 in section 300 is similar to the layout of reference conductor 250 along opposing sides 204a and 204b of ink feed slot 204 and along opposing sides 206a and 206b of ink feed slot 206 throughout printhead die 200.

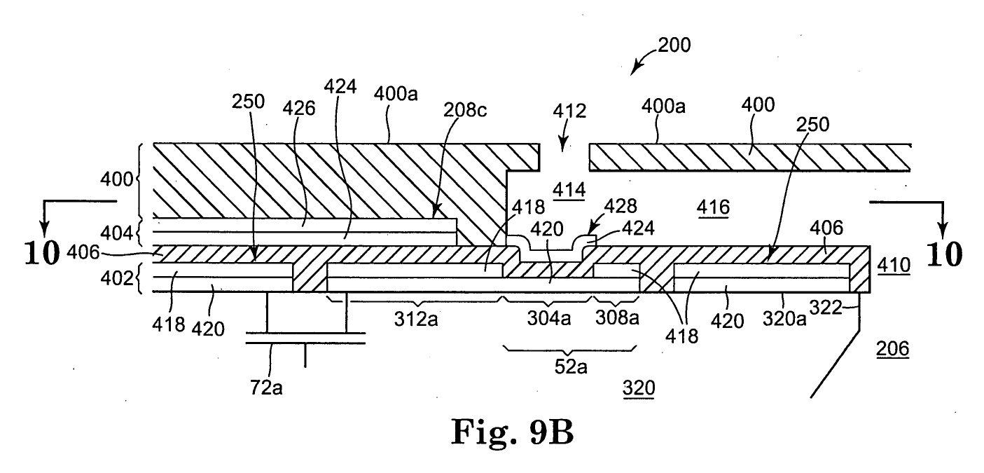

FIGS. 9A and 9B are diagrams illustrating partial cross-sections of one embodiment of printhead die 200 taken at the positions of lines 9A and 9B, respectively, in FIG. 8. FIGS. 9A and 9B are not drawn to scale for clarity.

Referring to FIGS. 9A and 9B, printhead die 200 includes an orifice layer 400, a first metal layer 402, a second metal layer 404, an isolation layer 406 and substrate 320. Drive switch 72a and ink feed slot 206 are formed in substrate 320 that includes a substrate surface 320a. The ink feed slot 206 includes ink feed slot edge 322 in communication with substrate surface 320a. The first metal layer 402 is formed on substrate surface 320a. Isolation layer 406 is formed on first metal layer 402 and substrate surface 320a.

The orifice layer 400 has a front face 400a and a nozzle opening 412 in the front face 400a. Orifice layer 400 also has a nozzle chamber or vaporization chamber 414 and a fluid path or ink feed path 416 formed therein. The firing resistor, indicated at 52a, is located at least partially under vaporization chamber 414, which is between firing resistor 52a and nozzle opening 412. The ink feed path 416 is located between vaporization chamber 414 and ink feed channel 410. The vaporization chamber 414 communicates with nozzle opening 412 and ink feed path 416. The ink feed path 416 communicates with vaporization chamber 414 and ink feed channel 410 that communicates with ink feed slot 206. The ink feed slot 206 supplies ink to vaporization chamber 414 through ink feed channel 410 and ink feed path 416.

The first metal layer 402 is formed on substrate 320 and insulated from second metal layer 404 by isolation layer 406. The first metal layer 402 includes a conductive layer 418 and a resistive layer 420. The conductive layer 418 is made of a suitable conductive material, for example aluminum-copper, and the resistive layer 420 is made of a suitable resistive material, for example tantalum-aluminum. The first metal layer 402 includes multiple leads and components in printhead die 200, including reference conductor 250, drive switch conductive lead 312a, fire line conductive lead 314a and firing resistor 52a.

The firing resistor 52a is made from first metal layer 402 and includes second resistive segment 306a and shorting bar 308a. The second resistive segment 306a includes resistive layer 420. Conductive layer 418 is not disposed on second resistive segment 306a. The shorting bar 308a includes conductive layer 418 and resistive layer 420. The second resistive segment 306a is electrically coupled to shorting bar 308a and fire line conductive lead 314a.

The fire line conductive lead 314a is made from first metal layer 402 and includes conductive layer 418 and resistive layer 420. The fire line conductive lead 314a is electrically coupled to second metal layer 404 through via 422 formed in isolation layer 406. The via 422 in isolation layer 406 is filled with material to electrically couple fire line conductive lead 314a to second metal layer 404.

The reference conductor 250 is disposed on substrate 320 over a portion of drive switch 72a and between firing resistor 52a and ink feed slot edge 322. The reference conductor 250 is electrically coupled to one side of the drain-source path of drive switch 72a. The other side of the drain-source path of drive switch 72a is electrically coupled to drive switch conductive lead 312a that is electrically coupled to first resistive segment 304a (shown in FIG. 9B) of firing resistor 52a. The reference conductor 250 and drive switch conductive lead 312a are formed as part of first metal layer 402 and include conductive layer 418 and resistive layer 420.

In one embodiment, isolation layer 406 comprises an insulating passivation layer disposed over first metal layer 402, including reference conductor 250 and firing resistor 52a. The isolation layer 406 is disposed along ink feed slot edge 322. The isolation layer 406 covers reference conductor 250 between firing resistor 52a and ink feed slot edge 322 and prevents ink from touching and corroding reference conductor 250.

In one embodiment, isolation layer 406 is disposed over shorting bar 308a and second resistive segment 306a and prevents ink from touching and corroding shorting bar 308a and second resistive segment 306a. In one embodiment, isolation layer 406 is disposed over fire line conductive lead 314a, drive switch conductive lead 312a and the portion of reference conductor 250 disposed over drive switch 72a. Via 422 is etched in isolation layer 406 to electrically couple fire line conductive lead 314a (first metal layer 402) and second metal layer 404. The isolation layer 406 is formed as part of a suitable insulating material. In one embodiment, isolation layer 406 includes two layers, for example a silicon-carbide layer and a silicon-nitride layer.

The second metal layer 404 includes fire line 208c that is electrically coupled through via 422 to fire line conductive lead 314a. The second metal layer 404 includes a first layer 424, made from a suitable material, for example tantalum, and a second layer 426 made from a suitable conductive material, for example gold. The first layer 424 is disposed to make contact with fire line conductive lead 314a through via 422. In addition, the first layer 424 is disposed at 428 on isolation layer 406 over second resistive segment 306a. The first layer 424 at 428 protects isolation layer 406 as ink is heated by firing resistor 52a. The second layer 426 is a conductive gold layer disposed on first layer 424 to form fire line 208c. The fire line 208c receives energy signal FIRE3 and provides energy pulses to second resistive segment 306a and firing resistor 52a to heat and eject ink from vaporization chamber 414 through nozzle 412.

Referring to FIG. 9B, firing resistor 52a is made from first metal layer 402 and includes first resistive segment 304a and shorting bar 308a. The first resistive segment 304a includes resistive layer 420. Conductive layer 418 is not disposed on first resistive segment 304a. The first resistive segment 304a is electrically coupled to shorting bar 308a and drive switch conductive lead 312a.

In one embodiment, isolation layer 406 is disposed over shorting bar 308a and first resistive segment 304a. In one embodiment, isolation layer 406 is disposed overdrive switch conductive lead 312a and a portion of reference conductor 250 disposed over drive switch 72a.

The first layer 424 of second metal layer 404 is disposed at 428 on isolation layer 406 over first resistive segment 304a. The first layer 424 at 428 protects the isolation layer 406 as ink is heated by firing resistor 52a.

In operation, memory circuit 74a is enabled and receives data to turn drive switch 72a on or off. The memory circuit 74a provides a voltage on the gate of drive switch 72a to either turn drive switch 72a on (conducting) or off (non-conducting). An energy pulse is received on fire line 208c and provided to second resistive segment 306a. If drive switch 72a is conducting, the energy pulse creates an energy current that flows through fire line 208c and fire line conductive lead 314a to second resistive segment 306a. The current flows through the second resistive segment 306a and shorting bar 308a to first resistive segment 304a and drive switch conductive lead 312a. The current flows through the conducting drain-source path of drive switch 72a to reference conductor 250 and out of printhead die 200. As the current flows through reference conductor 250, the current flows between firing resistor areas 326a-326c and to the portion of reference conductor 250 between firing resistors 52a and ink feed slot edge 322.

In the embodiment depicted in FIGS. 9A and 9B, conductive layer 418 has a height that is in a range of 0.3-1.5 μm, which in an exemplary embodiment is 0.5 μm, and resistive layer 420 is in a range of 0.3-1.5 μm, which in an exemplary embodiment is 0.5 μm. In this embodiment, first layer 424 has a height that is in a range of 0.3-1.5 μm, which in an exemplary embodiment is 0.36 μm, and second layer 426 that has a height similar to that of resistive layer 420.

An embodiment of the location of fire lines, and ground lines, address lines in metal layer 1 and metal layer 2 is depicted and disclosed in co-pending patent application Ser. No. 10/787,573 which is incorporated by reference in its entirety.

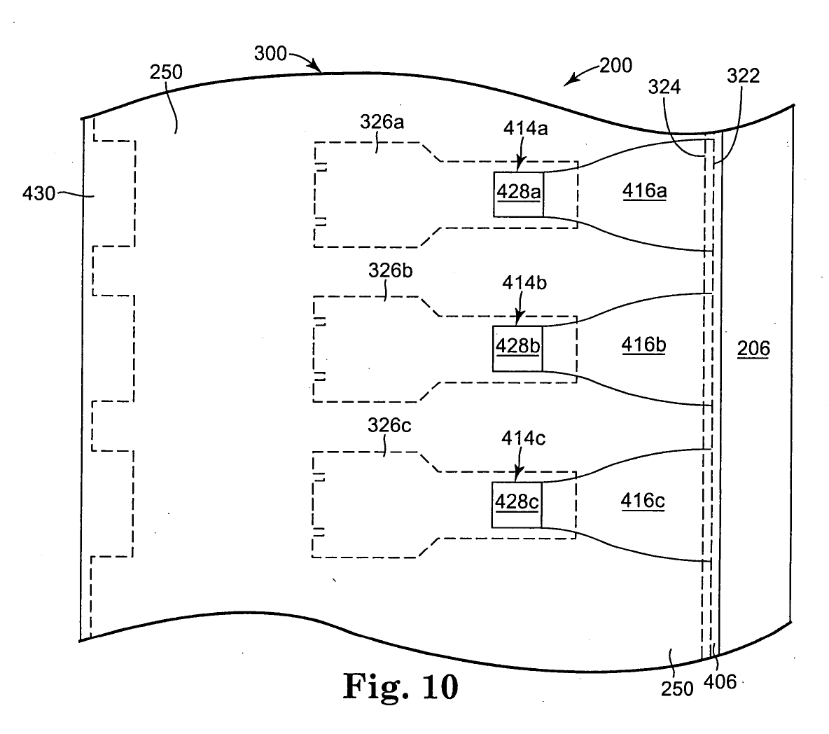

FIG. 10 is a diagram illustrating one embodiment of section 300 of printhead die 200 at the position of line 10 in FIG. 9B. The printhead die 200 includes ink feed slot 206, fluid paths or ink feed paths 416a-416c and vaporization chambers, indicated at 414a-414c. The ink feed paths 416a-416c and vaporization chambers 414a-414c correspond to firing cells 302a-302c. Ink feed path 416a and vaporization chamber 414a correspond to firing cell 302a. Ink feed path 416b and vaporization chamber 414b correspond to firing cell 302b, and ink feed path 416c and vaporization chamber 414c correspond to firing cell 302c.

The vaporization chambers 414a-414c include first layer 424 at 428a-428c over first resistive segments 304a-304c and second resistive segments 306a-306c. Vaporization chamber 414a includes first layer 424 at 428a over first resistive segment 304a and second resistive segment 306a. Vaporization chamber 414b includes first layer 424 at 428b over first resistive segment 304b and second resistive segment 306b. Vaporization chamber 414c includes first layer 424 at 428c over first resistive segment 304c and second resistive segment 306c.

The reference conductor 250 is situated on each side of firing resistor areas 326a-326c. The reference conductor 250 is situated between firing resistor areas 326a-326c and a memory circuit and routing channel area, indicated at 430. The reference conductor 250 is also situated between adjacent firing resistor areas 326a-326c. In addition, reference conductor 250 is disposed under ink feed paths 416a-416c and between firing resistor areas 326a-326c and ink feed slot edge 322. The reference conductor 250 at 324 is located next to ink feed slot edge 322 along the length of ink feed slot 206.

Ink feed slot 206 is fluidically coupled to ink feed paths 416a-416c, which are fluidically coupled to vaporization chambers 414a-414c, respectively. The reference conductor 250 is isolated by isolation layer 406 from ink flowing from ink feed slot 206 through ink feed paths 416a-416c. Ink from ink feed slot 206 flows through ink feed paths 416a-416c to vaporization chambers 414a-414c over isolation layer 406 that covers reference conductor 250.

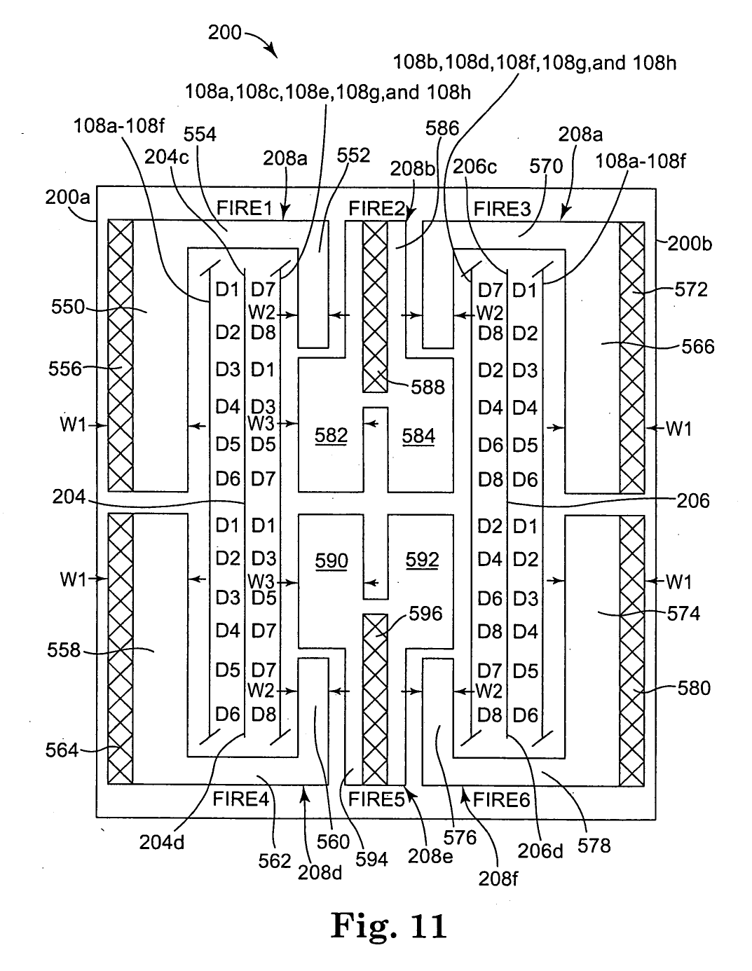

FIG. 11 is a block diagram illustrating a layout of fire lines 208a-208f in one embodiment of printhead die 200. The printhead die 200 includes fire lines 208a-208f, data lines 108a-108h and ink feed slots 204 and 206. Each of the fire lines 208a-208f corresponds to one of the fire groups 202a-202f and is electrically coupled to all firing resistors 52 in the corresponding fire group 202a-202f. Each of the data lines 108a-108h corresponds to one of the data line groups 212, 214, 216, 218, 220, 222, 224 and 226 and is electrically coupled to all firing cells 70 in the corresponding data line group 212, 214, 216, 218, 220, 22, 224 and 226. Each of the data lines 108a-108h is electrically coupled to firing cells 70 in each of the fire groups 202a-202f.

Data lines 108a-108h receive data signals D1-D8 and supply the data signals D1-D8 to firing cells 70 in each of the fire groups 202a-202f. Data line 108a receives data signal D1 and supplies data signal D1 to data line group 212 in each of the fire groups 202a-202f. Data line 108b receives data signal D2 and supplies data signal D2 to data line group 214 in each of the fire groups 202a-202f. Data line 108c receives data signal D3 and supplies data signal D3 to data line group 216 in each of the fire groups 202a-202f. Data line 108d receives data signal D4 and supplies data signal D4 to data line group 218 in each of the fire groups 202a-202f. Data line 108e receives data signal D5 and supplies data signal D5 to data line group 220 in each of the fire groups 202a-202f. Data line 108f receives data signal D6 and supplies data signal D6 to data line group 222 in each of the fire groups 202a-202f. Data line 108g receives data signal D7 and supplies data signal D7 to data line group 224 in each of the fire groups 202a-202f. Data line 108h receives data signal D8 and supplies data signal D8 to data line group 226 in each of the fire groups 202a-202f.

The data lines 108a-108h are disposed along ink feed slots 204 and 206 in printhead die 200. Portions of data lines 108a-108f are disposed along ink feed slot 204 and between ink feed slot 204 and printhead die side 200a. Other portions of data lines 108a-108f are disposed along ink feed slot 206 and between ink feed slot 206 and printhead die side 200b. Also, portions of data lines 108a, 108c, 108e, 108g and 108h are disposed along ink feed slot 204, between ink feed slot 204 and ink feed slot 206 and portions of data lines 108b, 108d, 108f, 108g and 108h are disposed along ink feed slot 206, between ink feed slot 206 and ink feed slot 204.

The portions of data lines 108a-108f disposed between ink feed slot 204 and printhead die side 200a are electrically coupled to firing cells 70 in data lines groups 212a, 214a, 216a, 218a, 220a and 222a in FG1 at 202a, and to firing cells 70 in data line groups 212d, 214d, 216d, 218d, 220d and 222d in FG4 at 202d. Data line 108a is electrically coupled to firing cells 70 in data line groups 212a and 212d. Data line 108b is electrically coupled to firing cells 70 in data line groups 214a and 214d. Data line 108c is electrically coupled to firing cells 70 in data line groups 216a and 216d. Data line 108d is electrically coupled to firing cells 70 in data line groups 218a and 218d. Data line 108e is electrically coupled to firing cells in data line groups 220a and 220d. Data line 108f is electrically coupled to firing cells 70 in data line groups 222a and 222d.

The portions of data lines 108a-108f disposed between ink feed slot 206 and printhead die side 200b are electrically coupled to firing cells 70 in data line groups 212c, 214c, 216c, 218c, 220c and 222c in FG3 at 202c and to firing cells 70 in data line groups 212f, 214f, 216f, 218f, 220f and 222f in FG6 at 202f. Data line 108a is electrically coupled to firing cells 70 in data line groups 212c and 212f. Data line 108b is electrically coupled to firing cells 70 in data line groups 214c and 214f. Data line 108c is electrically coupled to firing cells in data line groups 216c and 216f. Data line 108d is electrically coupled to firing cells 70 in data line groups 218c and 218f. Data line 108e is electrically coupled to firing cells 70 in data line groups 220c and 220f. Data line 108f is electrically coupled to firing cells 70 in data line groups 222c and 222f.

The portions of data lines 108a, 108c, 108e, 108g and 108h disposed along ink feed slot 204, between ink feed slot 204 and ink feed slot 206, are electrically coupled to firing cells 70 in FG1 at 202a, FG2 at 202b, FG4 at 202d and FG5 at 202e. Data line 108a is electrically coupled to firing cells in data line groups 212b and 212e. Data line 108c is electrically coupled to firing cells 70 in data line groups 216b and 216e. Data line 108e is electrically coupled to firing cells 70 in data line groups 220b and 220e. Data line 108g is electrically coupled to firing cells 70 in data line groups 224a, 224b, 224d and 224e. Data line 108h is electrically coupled to firing cells 70 in data line groups 226a and 226d.

The portions of data lines 108b, 108d, 108f, 108g and 108h disposed along ink feed slot 206 and between ink feed slot 206 and ink feed slot 204 are electrically coupled to firing cells 70 in FG2 at 202b, FG3 at 202c, FG5 at 202e and FG6 at 202f. Data line 108b is electrically coupled to firing cells 70 in data line groups 214b and 214e. Data line 108d is electrically coupled to firing cells 70 in data line groups 218b and 218e. Data line 108f is electrically coupled to firing cells 70 in data line groups 222b and 222e. Data line 108g is electrically coupled to firing cells 70 in data line groups 224c and 224f, and data line 108h is electrically coupled to firing cells 70 in data line groups 226b, 226c, 226e and 226f.

The fire lines 208a-208f receive energy signals FIRE1, FIRE2, . . . FIRE6 and supply the energy signals FIRE1, FIRE2 . . . FIRE6 to firing cells 70 in fire groups 202a-202f. Fire line 208a receives energy signal FIRE1 and supplies the energy signal FIRE1 to all firing cells 70 in FG1 at 202a. Fire line 208b receives energy signal FIRE2 and supplies the energy signal FIRE2 to all firing cells 70 in FG2 at 202b. Fire line 208c receives energy signal FIRE3 and supplies the energy signal FIRE3 to all firing cells 70 in FG3 at 202c. Fire line 208d receives energy signal FIRE4 and supplies the energy signal FIRE4 to all firing cells 70 in FG4 at 202d. Fire line 208e receives energy signal FIRE5 and supplies the energy signal FIRE5 to all firing cells 70 in FG5 at 202e. Fire line 208f receives energy signal FIRE6 and supplies the energy signal FIRE6 to all firing cells 70 in FG6 at 202f.

Each fire line 208a-208f supplies energy to firing resistors 52 that are coupled to conducting drive switches 72. Energy is supplied to firing resistors 52 through the energy signals FIRE1, FIRE2, . . . FIRE6. The energy heats the firing resistors 52 to heat and eject ink from drop generators 60. Variations in the amount of energy supplied to firing resistors 52 can result in ink drops that are not uniform in size and shape, resulting in a distorted printed image. To uniformly eject ink, each fire line 208a-208f is configured to maintain a suitable energy variation between firing resistors 52.

Energy variation is the maximum percent difference in power dissipated through any two firing resistors 52 in one of the fire groups 202a-202f. The highest power is generally provided to the firing resistor 52 nearest the bond pad receiving the energy signal FIRE1, FIRE2, . . . FIRE6 as only a single firing resistor 52 is energized. The lowest power is generally provided to the firing resistor 52 that is the furthest from the bond pad receiving the energy signal FIRE1, FIRE2, . . . FIRE6 as all firing resistors 52 in a row subgroup are energized. Layout contributions to energy variation include fire line length, fire line width, fire line conductor thickness and ground line, e.g. reference conductor 250, dimensions. In an exemplary embodiment, the ground line portions, e.g. each of reference conductor portions 250a, 250b, 250c, and 250d, are less than 800 um wide, an in one embodiment about 96 μum wide. In this exemplary embodiment, fire lines may be between 50 and 500 um wide. These dimensions are for one exemplary embodiment; other embodiments may employ other sizes and dimensions. Energy variations of 10-15% are preferred and energy variations up to 20% have been found to be suitable energy variations.

The fire groups 202a-202f and fire lines 208a-208f are disposed in printhead die 200 to achieve a suitable energy variation between firing resistors 52. Instead of all firing cells 70 in one fire group 202a-202f being disposed along one side of one ink feed slot 204 or 206, resulting in a long fire line 208a-208f, the firing cells 70 in one fire group 202a-202f are disposed along opposing sides of one ink feed slot 204 or 206, or along both ink feed slots 204 and 206. This reduces the length of the corresponding fire line 208a-208f.

The firing cells 70 in fire group 202a are disposed along opposing sides of ink feed slot 204 and the firing cells 70 in fire group 202d are also disposed along opposing sides of ink feed slot 204. Each of the fire lines 208a and 208d is disposed along the opposing sides of ink feed slot 204 and joined at one end 204c or 204d of ink feed slot 204. Each fire line 208a and 208d is longer along one side of ink feed slot 204, as compared to along the other side of ink feed slot 204, to form substantially J-shaped fire lines 208a and 208d.

The firing cells 70 in fire group 202c are disposed along opposing sides of ink feed slot 206 and the firing cells 70 in fire group 202f are also disposed along opposing sides of ink feed slot 206. Each fire line 208c and 208f is disposed along opposing sides of ink feed slot 206 and joined at one end 206c or 206d of ink feed slot 206. Each fire line 208c and 208f is longer along one side of ink feed slot 206, as compared to along the other side of ink feed slot 206, to form substantially J-shaped fire lines 208c and 208f.

The firing cells 70 in fire group 202b are disposed along both ink feed slots 204 and 206, and the firing cells 70 in fire group 202e are disposed along both ink feed slots 204 and 206. Each fire line 208b and 208e is disposed along both ink feed slots 204 and 206 and joined between ink feed slots 204 and 206. Each fire line 208b and 208e includes a post section disposed between ink feed slots 204 and 206. The post section extends the fire line 208b and 208e to one side of printhead die 200 and forms substantially fork-shaped (or goal-post shaped) fire lines 208b and 208e. The substantially J-shaped and substantially fork-shaped fire lines 208a-208f can be shorter in length than fire lines that extend along only one side of one ink feed slot 204 or 206.

The substantially J-shaped fire line 208a is electrically coupled to firing cells 70 disposed along each of the opposing sides of ink feed slot 204. A first section, indicated at 550, is electrically coupled to firing cells 70 in six data line groups 212a, 214a, 216a, 218a, 220a and 222a in FG1 at 202a. A second section, indicated at 552, is electrically coupled to firing cells 70 in two data line groups 224a and 226a in FG1 at 202a. The first section 550 is electrically coupled to the second section 552 through a third section 554 at one end 204c of ink feed slot 204. The first section 550 is longer than the second section 552 in the y-direction along the length of ink feed slot 204.

The first section 550 supplies the energy signal FIRE1 to up to six firing resistors 52 coupled to conducting drive switches 72. The second section 552 supplies the energy signal FIRE1 to up to two firing resistors 52 coupled to conducting drive switches 72. The first section 550 is wider at W1 than the second section 552 at W2. The first section 550, second section 552 and third section 554 are formed as part of second metal layer. In addition, the first section 550 includes a dual layer metal section, indicated with cross-hatching at 556, formed as part of second metal layer electrically coupled to first metal layer along printhead die side 200a. The dual layer section 556 and the width W1 of first section 550 maintain a suitable energy variation between firing resistors 52.

The substantially J-shaped fire line 208d is electrically coupled to firing cells 70 disposed along each of the opposing sides of ink feed slot 204. A first section, indicated at 558, is electrically coupled to firing cells 70 in six data line groups 212d, 214d, 216d, 218d, 220d and 222d in FG4 at 202d. A second section, indicated at 560, is electrically coupled to firing cells 70 in two data line groups 224d and 226d in FG4 at 202d. The first section 558 is electrically coupled to the second section 560 through a third section 562 at one end 204d of ink feed slot 204. The first section 558 is longer than the second section 560 in the y-direction along the length of ink feed slot 204.

The first section 558 supplies the energy signal FIRE4 to up to six firing resistors 52 coupled to conducting drive switches 72. The second section 560 supplies the energy signal FIRE4 to up to two firing resistors 52 coupled to conducting drive switches 72. The first section 558 is wider at W1 than the second section 560 at W2. The first section 558, second section 560 and third section 562 are formed as part of second metal layer. In addition, the first section 558 includes a dual layer metal section, indicated with cross-hatching at 564, formed as part of second metal layer electrically coupled to first metal layer along printhead die side 200a. The dual layer section 564 and width W1 of first section 558 maintain a suitable energy variation between firing resistors 52.

The substantially J-shaped fire line 208c is electrically coupled to firing cells 70 disposed along each of the opposing sides of ink feed slot 206. A first section, indicated at 566, is electrically coupled to firing cells 70 in six data line groups 212c, 214c, 216c, 218c, 220c and 222c in FG3 at 202c. A second section, indicated at 568, is electrically coupled to firing cells 70 in two data line groups 224c and 226c in FG3 at 202c. The first section 566 is electrically coupled to the second section 568 through a third section 570 at one end 206c of ink feed slot 206. The first section 566 is longer than the second section 568 in the y-direction along the length of ink feed slot 206.

The first section 566 supplies the energy signal FIRE3 to up to six firing resistors 52 coupled to conducting drive switches 72. The second section 568 supplies the energy signal FIRE3 to up to two firing resistors 52 coupled to conducting drive switches 72. The first section 566 is wider at W1 than the second section 568 at W2. The first section 566, second section 568 and third section 570 are formed as part of second metal layer. In addition, the first section 566 includes a dual layer metal section, indicated with cross-hatching at 572, formed as part of second metal layer electrically coupled to first metal layer along printhead die side 200b. The dual layer section 572 and the width W1 of first section 566 maintain a suitable energy variation between firing resistors 52.

The substantially J-shaped fire line 208f is electrically coupled to firing cells 70 disposed along each of the opposing sides of ink feed slot 206. A first section, indicated at 574, is electrically coupled to firing cells 70 in six data line groups 212f, 214f, 216f, 218f, 220f and 222f in FG6 at 202f. A second section, indicated at 576, is electrically coupled to firing cells 70 in two data line groups 224f and 226f in FG6 at 202f. The first section 574 is electrically coupled to the second section 576 through a third section 578 at one end 206d of ink feed slot 206. The first section 574 is longer than the second section 576 in the y-direction along the length of ink feed slot 206.

The first section 574 supplies the energy signal FIRE6 to up to six firing resistors 52 coupled to conducting drive switches 72. The second section 576 supplies the energy signal FIRE6 to up to two firing resistors 52 coupled to conducting drive switches 72. The first section 574 is wider at W1 than the second section 576 at W2. The first section 574, second section 576 and third section 578 are formed as part of second metal layer. In addition, the first section 574 includes a dual layer metal section, indicated with cross-hatching at 580, formed as part of second metal layer electrically coupled to first metal layer along printhead die side 200b. The dual layer section 580 and width W1 of first section 574 maintain a suitable energy variation between firing resistors 52.

The substantially fork-shaped fire line 208b is electrically coupled to firing cells 70 disposed along each ink feed slot 204 and 206. A first section, indicated at 582, is electrically coupled to firing cells 70 in four data line groups 212b, 216b, 220b and 224b in FG2 at 202b. The second section, indicated at 584, is electrically coupled to firing cells 70 in four data line groups 214b, 218b, 222b and 226b in FG2 at 202b. The first section 582 is electrically coupled to the second section 584 through a third section or post section 586. The first section 582 is similar in length along the y-direction and width along the x-direction to the second section 584.

The first section 582 supplies the energy signal FIRE2 to up to four firing resistors 52 coupled to conducting drive switches 72. The second section 584 supplies the energy signal FIRE2 to up to four firing resistors 52 coupled to conducting drive switches 72. The first section 582 and the second section 584 are formed as part of second metal layer and are wider at W3 than the section width W2.

The third section 586 supplies the energy signal FIRE2 to up to eight firing resistors 52 coupled to conducting drive switches 72. The third section 586 is formed as part of second metal layer and includes a post dual layer metal section, indicated with cross-hatching at 588. The post dual layer metal section at 588 includes second metal layer electrically coupled to first metal layer. The post dual layer metal section 588 and the width W3 of first and second sections 582 and 584 maintain a suitable energy variation between the firing resistors 52.

The substantially fork-shaped fire line 208e is electrically coupled to firing cells 70 disposed along each ink feed slot 204 and 206. A first section, indicated at 590, is electrically coupled to firing cells 70 in four data line groups 212e, 216e, 220e and 224e in FG5 at 202e. The second section, indicated at 592, is electrically coupled to firing cells 70 in four data line groups 214e, 218e, 222e and 226e in FG5 at 202e. The first section 590 is electrically coupled to the second section 592 through a third section or post section 594. The first section 590 is similar in length along the y-direction and width along the x-direction to the second section 592.

The first section 590 supplies the energy signal FIRE5 to up to four firing resistors 52 coupled to conducting drive switches 72. The second section 592 supplies the energy signal FIRE5 to up to four firing resistors 52 coupled to conducting drive switches 72. The first section 590 and the second section 592 are formed as part of second metal layer and are wider at W3 than the section width W2.

The third section 594 supplies the energy signal FIRE5 to up to eight firing resistors 52 coupled to conducting drive switches 72. The third section 594 is formed as part of second metal layer and includes a post dual layer metal section, indicated with cross-hatching at 596. The post dual layer metal section at 596 includes second metal layer electrically coupled to first metal layer. The post dual layer metal section 596 and the width W3 of first and second sections 590 and 592 maintain a suitable energy variation between the firing resistors 52.

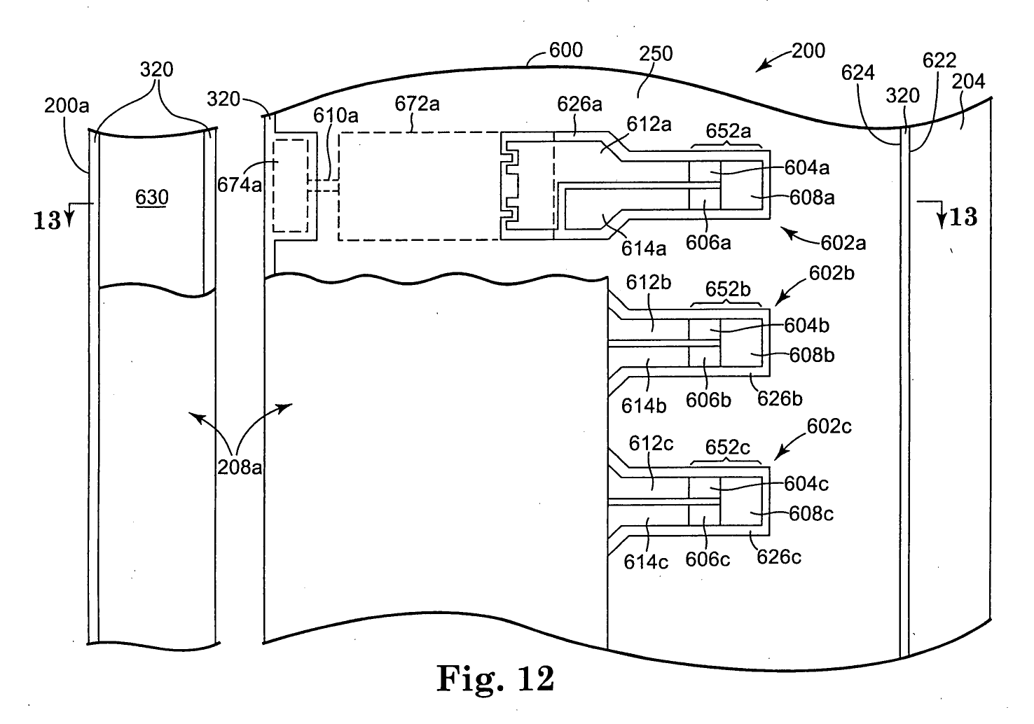

FIG. 12 is a plan view diagram illustrating one embodiment of a section 600 of printhead die 200. The section 600 includes three firing cells, indicated at 602a-602c, ink feed slot 204, reference conductor 250 and fire line 208a. The three firing cells 602a-602c are similar to firing cells 70 that are disposed throughout printhead die 200 and instances of firing cells 70 that are part of data line group D1 at 212a in FG1 at 202a. The firing cells 602a-602c include firing resistors 52, memory circuits 74 and drive switches 72, such as firing resistors 652a-652c memory circuit 674a and drive switch 672a. The fire line 208a has been cut away to reveal firing cell 602a.

The firing cell 602a includes memory circuit 674a, drive switch 672a and firing resistor 652a. The firing resistor 652a includes a first resistive segment 604a, a second resistive segment 606a and a conductive shorting bar 608a. The first resistive segment 604a and second resistive segment 606a are separate resistive segments electrically coupled together through conductive shorting bar 608a. The memory circuit 674a is electrically coupled to the gate of drive switch 672a through a substrate lead 610a. One side of the drain-source path of drive switch 672a is electrically coupled to reference conductor 250. The reference conductor 250 contacts drive switch 672a where the reference conductor 250 is disposed over drive switch 672a. The other side of the drain-source path of drive switch 672a is electrically coupled to a drive switch conductive lead 612a that electrically couples the drain-source path of drive switch 672a to first resistive segment 604a. The second resistive segment 606a is electrically coupled to fire line 208a through fire line conductive lead 614a.

The firing cell 602b includes a memory circuit and drive switch disposed under fire line 208a and a firing resistor 652b that is not disposed under fire line 208a. The firing resistor 652b includes a first resistive segment 604b, a second resistive segment 606b and a conductive shorting bar 608b. The first resistive segment 604b and second resistive segment 606b are separate resistive segments electrically coupled together through conductive shorting bar 608b. The memory circuit and drive switch of firing cell 602b are electrically coupled together through a substrate lead and one side of the drain-source path of the drive switch is electrically coupled to reference conductor 250. The reference conductor 250 contacts the drive switch where the reference conductor 250 is disposed over the drive switch. The other side of the drain-source path of the drive switch is electrically coupled to a drive switch conductive lead 612b that electrically couples the drain-source path of the drive switch to first resistive segment 604b. The second resistive segment 606b is electrically coupled to fire line 208a through fire line conductive lead 614b.

The firing cell 602c includes a memory circuit and drive switch disposed under fire line 208a and a firing resistor 652c that is not disposed under fire line 208a. The firing resistor 652c includes a first resistive segment 604c, a second resistive segment 606c and a conductive shorting bar 608c. The first resistive segment 604c and second resistive segment 606c are separate resistive segments electrically coupled together through conductive shorting bar 608c. The memory circuit and drive switch of firing cell 602c are electrically coupled together through a substrate lead and one side of the drain-source path of the drive switch is electrically coupled to reference conductor 250. The reference conductor 250 contacts the drive switch where the reference conductor 250 is disposed over the drive switch. The other side of the drain-source path of the drive switch is electrically coupled to a drive switch conductive lead 612c that electrically couples the drain-source path of the drive switch to first resistive segment 604c. The second resistive segment 606c is electrically coupled to fire line 208a through fire line conductive lead 614c.

The firing cells 602a-602c are formed in and on semi-conductor substrate 320 of printhead die 200. The memory circuits 74, such as memory circuit 674a, drive switches 72, such as drive switch 672a, and substrate leads, such as substrate lead 610a, are formed in substrate 320 of printhead die 200. The reference conductor 250, drive switch conductive leads 612a-612c, fire line conductive leads 614a-614c and shorting bars 608a-608c are formed as part of the first metal layer that is formed on substrate 320. In addition, first resistive segments 604a-604c and second resistive segments 606a-606c are formed as part of a resistive layer.

The ink feed slot 204 is formed in substrate 320 and provides ink to firing resistors 652a-652c. The ink feed slot 204 includes an ink feed slot edge 622 at the surface of substrate 320. The ink feed slot edge 622 is in communication with the surface of substrate 320 along the length of ink feed slot 204. The reference conductor 250 is disposed along ink feed slot 204 and spaced apart from ink feed slot edge 622 and is formed as part of first metal layer at 624. Opposing side 204a of the ink feed slot 204 includes ink feed slot edge 622 and opposing side 204b of ink feed slot 204 includes an ink feed slot edge similar to ink feed slot edge 622. In addition, each of the opposing sides 206a and 206b of ink feed slot 206 includes an ink feed slot edge in communication with the surface of substrate 320 and similar to ink feed slot edge 622.

The reference conductor 250 is formed as part of the first metal layer and disposed between memory circuits 74, such as memory circuit 74a, and ink feed slot 204. The drive switch conductive leads 612a-612c, fire line conductive leads 614a-614c and firing resistors 652a-652c are isolated from reference conductor 250 and disposed in firing resistor areas 626a-626c. Firing resistor area 626a includes drive switch conductive lead 612a, fire line conductive lead 614a and firing resistor 652a. Firing resistor area 626b includes drive switch conductive lead 612b, fire line conductive lead 614b and firing resistor 652b. Firing resistor area 626c includes drive switch conductive lead 612c, fire line conductive lead 614c and firing resistor 652c.

The reference conductor 250 is disposed over a portion of each of the drive switches 72 and between memory circuit 74 and firing resistor areas 626a-626c. The reference conductor 250 is also disposed between ink feed slot edge 622 and firing resistor areas 626a-626c. In addition, the reference conductor 250 is disposed between firing resistor areas 626a-626c. The reference conductor 250 is substantially planar between memory circuit 74 and ink feed slot edge 322. The reference conductor 250 has a larger or increased area due to the portion of reference conductor 250 that is disposed between ink feed slot edge 622 and firing resistor areas 626a-626c. The larger area reference conductor 250 reduces the energy variation between firing cells and provides a more uniform ink pattern.

The fire line 208a includes a second metal layer that is disposed over portions of the firing resistor areas 626a-626c and disposed from the firing resistor areas 626a-626c to one side 200a of printhead die 200. The second metal layer of fire line 208a is disposed over portions of drive switch conductive leads 612a-612c and fire line conductive leads 614a-614c, and electrically coupled to fire line conductive leads 614a-614c through vias from the second metal layer to the first metal layer. The second metal layer of fire line 208a is also disposed over portions of the reference conductor 250 disposed between the firing resistor areas 626a-626c and memory circuits 74. In addition, the second metal layer of fire line 208a is disposed over enable and data lines routed in the first metal layer between the reference conductor 250 and the one side 200a of printhead die 200. The fire line 208a includes a dual layer section at 556 that includes the first metal layer at 630 electrically coupled through a via to the second metal layer of fire line 208a. The dual layer section at 556 is disposed along one side 200a of printhead die 200.

In operation, one of the firing cells 602a-602c is fired or energized at a time. In one example operation, memory circuit 674a provides a voltage level on the gate of drive switch 672a to turn drive switch 672a on or off. Fire line 208a receives energy signal FIRE1 and provides an energy pulse to second resistive segment 606a through fire line conductive lead 614a.

If drive switch 672a is conducting, the energy pulse provides a current through firing resistor 652a, drive switch conductive lead 612a and drive switch 672a to reference conductor 250. With reference conductor 250 electrically coupled to a reference voltage, for example ground, the current flows through reference conductor 250 to ground.

The layout of firing cells 602a-602c in section 600 is similar to the layout of firing cells 70 along ink feed slots 204 and 206 throughout printhead die 200. In addition, the layout of fire line 208a and reference conductor 250 in section 600 is similar to the layout of fire lines 208 and reference conductor 250 throughout printhead die 200.

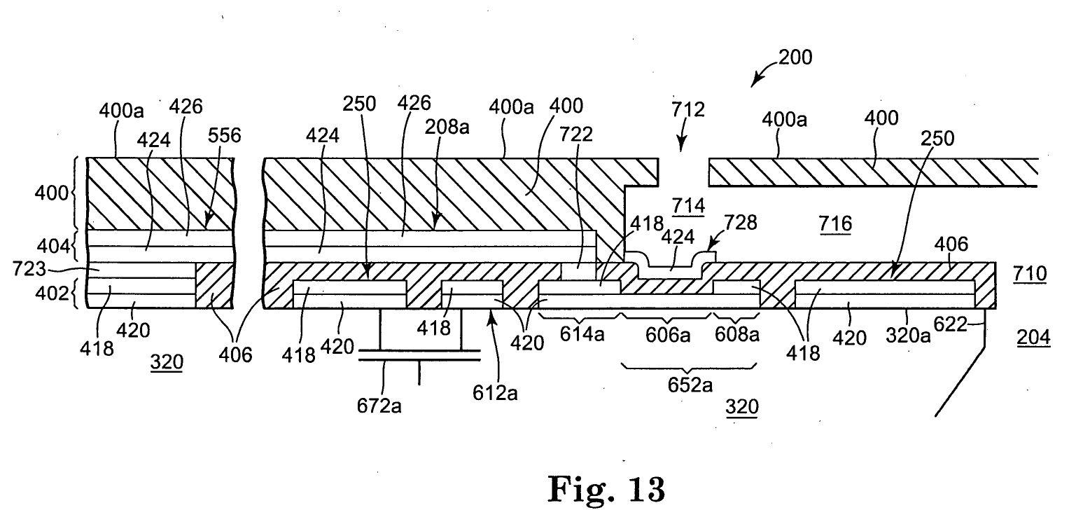

FIG. 13 is a diagram illustrating a partial cross-section of one embodiment of printhead die 200 taken at the position of line 13 in FIG. 12. FIG. 13 is not drawn to scale for clarity. The partial cross-section includes orifice layer 400, second metal layer 404, isolation layer 406, first metal layer 402 and substrate 320. Drive switch 672a and ink feed slot 204 are formed in substrate 320 that includes a substrate surface 320a. The ink feed slot 204 includes ink feed slot edge 622 in communication with substrate surface 320a. The first metal layer 402 is formed on substrate surface 320a. Isolation layer 406 is formed on first metal layer 402 and substrate surface 320a and defines ink feed channel 710.

The orifice layer 400 has a front face 400a and a nozzle opening 712 in the front face 400a. Orifice layer 400 also has a nozzle chamber or vaporization chamber 714 and a fluid path or ink feed path 716 formed therein. The firing resistor, indicated at 652a, is located at least partially under vaporization chamber 714, which is between firing resistor 652a and nozzle opening 712. The ink feed path 716 is located between vaporization chamber 714 and ink feed channel 710. The vaporization chamber 714 communicates with nozzle opening 712 and ink feed path 716. The ink feed path 716 communicates with vaporization chamber 714 and ink feed channel 710 that communicates with ink feed slot 204. The ink feed slot 204 supplies ink to vaporization chamber 714 through ink feed channel 710 and ink feed path 716.

The first metal layer 402 is formed on substrate 320 and insulated from second metal layer 404 by isolation layer 406. The first metal layer includes a conductive layer 418 and a resistive layer 420. The conductive layer 418 is made of a suitable conductive material, for example aluminum-copper, and the resistive layer 420 is made of a suitable resistive material, for example tantalum-aluminum. The first metal layer 402 includes in one embodiment multiple leads and components, including reference conductor 250, drive switch conductive lead 612a, fire line conductive lead 614a, firing resistor 652a and a portion of fire line 208a.

The firing resistor 652a is made from first metal layer 402 and includes second resistive segment 606a and shorting bar 608a. The second resistive segment 606a includes resistive layer 420. Conductive layer 418 is not disposed on second resistive segment 606a. The shorting bar 608a includes conductive layer 418 and resistive layer 420. The second resistive segment 606a is electrically coupled to shorting bar 608a and fire line conductive lead 614a.

The fire line conductive lead 614a is made from first metal layer 402 and includes conductive layer 418 and resistive layer 420. The fire line conductive lead 614a is electrically coupled to second metal layer 404 through via 722 formed in isolation layer 406. The via 722 in isolation layer 406 is filled with conductive material to electrically couple fire line conductive lead 614a to second metal layer 404.

The reference conductor 250 is disposed on substrate 320 over a portion of drive switch 672a and between firing resistor 652a and ink feed slot edge 622. The reference conductor 250 is electrically coupled to one side of the drain-source path of drive switch 672a. The other side of the drain-source path of drive switch 672a is electrically coupled to drive switch conductive lead 612a that is electrically coupled to first resistive segment 604a of firing resistor 652a. The reference conductor 250 and drive switch conductive lead 612a are formed as part of first metal layer 402 and include conductive layer 418 and resistive layer 420.

The isolation layer 406 is an insulating passivation layer disposed over first metal layer 402, including reference conductor 250 and firing resistor 652a. The isolation layer 406 defines ink feed channel 710 and is disposed along ink feed slot edge 622. The isolation layer 406 covers reference conductor 250 between firing resistor 652a and ink feed slot edge 622 and prevents ink from touching and corroding reference conductor 250. The isolation layer 406 is also disposed over shorting bar 608a and second resistive segment 606a and prevents ink from touching and corroding shorting bar 608a and second resistive segment 606a. In addition, isolation layer 406 is disposed over fire line conductive lead 614a, drive switch conductive lead 612a and reference conductor 250 situated over drive switch 672a. The via 722 is etched in isolation layer 406 to electrically couple fire line conductive lead 614a to second metal layer 404. A via 723 is etched in isolation layer 406 and filled with a conductive material to electrically couple second metal layer 404 to first metal layer 402 to form dual layer section 556. The isolation layer 406 is formed as part of a suitable insulating material. In one embodiment, isolation layer 406 includes two layers, for example, a silicon-carbide layer and a silicon-nitride layer.

A portion of fire line 208a is formed in second metal layer 404 and is electrically coupled through via 722 to fire line conductive lead 614a. The second metal layer 404 includes a first layer 424, made from a suitable material, for example tantalum, and a second layer 426 made from a suitable conductive material, for example gold. The first layer 424 is disposed to make contact with fire line conductive lead 614a through via 722. The first layer 424 is also disposed to make contact with first metal layer 402 through via 723 to form the dual layer section 556 of fire line 208a. In addition, the first layer 424 is disposed at 728 on isolation layer 406 over second resistive segment 606a. The first layer 424 at 728 protects isolation layer 406 as ink is heated by firing resistor 652a. The second layer 426 is a conductive gold layer disposed on first layer 424 to form a portion of fire line 208a. The fire line 208a receives energy signal FIRE1 and supplies energy pulses to fire line conductive lead 614a and second resistive segment 606a, through firing resistor 652a to heat and eject ink from vaporization chamber 714 through nozzle 712.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A fluid ejection device comprising:
a first fluid feed source having a first fluid feed source edge in communication with a substrate surface;
first firing resistors disposed along the first fluid feed source and configured to respond to a first current to heat fluid provided by the first fluid feed source; and
a reference conductor configured to conduct the first current from the first firing resistors, wherein the reference conductor is disposed between the first fluid feed source edge and the first firing resistors.

2. The fluid ejection device of claim 1, wherein the reference conductor is disposed between at least two of the first firing resistors.

3. The fluid ejection device of claim 1, comprising drive switches, wherein each of the drive switches is electrically coupled to a corresponding first firing resistor of the first firing resistors and the reference conductor is disposed over a portion of the drive switches.

4. The fluid ejection device of claim 1, comprising firing resistor areas disposed along the first fluid feed source, wherein the reference conductor is disposed between at least two adjacent firing resistor areas.

5. The fluid ejection device of claim 1, comprising drive switches formed in a first layer and firing resistor areas formed in a second layer disposed along the first fluid feed source, wherein the reference conductor is disposed between adjacent firing resistor areas and over a portion of the drive switches.

6. The fluid ejection device of claim 1, comprising drive switches, wherein each of the drive switches is electrically connected to a corresponding first firing resistor of the first firing resistors and the reference conductor.

7. The fluid ejection device of claim 1, comprising drive switches, wherein each of the drive switches is a field effect transistor that is electrically connected between a corresponding first firing resistor and the reference conductor.

8. The fluid ejection device of claim 1, wherein the reference conductor is disposed along the entire length of the first fluid feed source.

9. The fluid ejection device of claim 1, wherein the reference conductor is disposed along opposing sides of the first feed slot and along the entire length of the opposing sides of the first fluid feed source.

10. The fluid ejection device of claim 1, wherein the first firing resistors are disposed along opposing sides of the first fluid feed source and the reference conductor is disposed between the first firing resistors and the first fluid feed source edge along one of the opposing sides of the first fluid feed source and the first firing resistors and a second fluid feed source edge along another one of the opposing sides of the first fluid feed source.

11. The fluid ejection device of claim 1, comprising second firing resistors disposed along the first fluid feed source and configured to respond to a second current to heat fluid provided by the first fluid feed source, wherein the reference conductor is configured to conduct the second current from the second firing resistors and the reference conductor is disposed between the first fluid feed source edge and the second firing resistors.

12. The fluid ejection device of claim 11, wherein the second firing resistors are disposed on opposing sides of the first fluid feed source and the reference conductor is disposed between the second firing resistors and the first fluid feed source edge along one of the opposing sides of the first fluid feed source and the second firing resistors and a second fluid feed source edge along another one of the opposing sides of the first fluid feed source.

13. The fluid ejection device of claim 11, comprising a second fluid feed source and third firing resistors disposed along the second fluid feed source and configured to respond to a third current to heat fluid provided by the second fluid feed source, wherein the reference conductor is configured to conduct the third current from the third firing resistors, and the reference conductor is disposed between the third firing resistors and a second fluid feed source edge along the second fluid feed source.

14. The fluid ejection device of claim 13, wherein the third firing resistors are disposed on opposing sides of the second fluid feed source and the reference conductor is disposed between the third firing resistors and the second fluid feed source edge along one of the opposing sides of the second fluid feed source and the third firing resistors and a third fluid feed source edge along another one of the opposing sides of the second fluid feed source.

15. The fluid ejection device of claim 13, comprising fourth firing resistors disposed along the second fluid feed source and configured to respond to a fourth current to heat fluid provided by the second fluid feed source, wherein the reference conductor is configured to conduct the fourth current from the fourth firing resistors and the reference conductor is disposed between the second fluid feed source edge and the fourth firing resistors.

16. The fluid ejection device of claim 15, wherein the fourth firing resistors are disposed on opposing sides of the second fluid feed source and the reference conductor is disposed between the fourth firing resistors and the second fluid feed source edge along one of the opposing sides of the second fluid feed source and the fourth firing resistors and a third fluid feed source edge along another one of the opposing sides of the second fluid feed source.

17. The fluid ejection device of claim 15, comprising fifth firing resistors, wherein a first portion of the fifth firing resistors are disposed along the first fluid feed source and configured to respond to a fifth current to heat fluid provided by the first fluid feed source and a second portion of the fifth firing resistors are disposed along the second fluid feed source and configured to respond to the fifth current to heat fluid provided by the second fluid feed source, wherein the reference conductor is configured to conduct the fifth current from the fifth firing resistors and is disposed between the first fluid feed source edge and the first portion of the fifth firing resistors and between the second fluid feed source edge and the second portion of the fifth firing resistors.

18. The fluid ejection device of claim 17, comprising sixth firing resistors, wherein a first portion of the sixth firing resistors are disposed along the first fluid feed source and configured to respond to a sixth current to heat fluid provided by the first fluid feed source and a second portion of the sixth firing resistors are disposed along the second fluid feed source and configured to respond to the sixth current to heat fluid provided by the second fluid feed source, wherein the reference conductor is configured to conduct the sixth current from the sixth firing resistors and is disposed between the first fluid feed source edge and the first portion of the sixth firing resistors and between the second fluid feed source edge and the second portion of the sixth firing resistors.

19. The fluid ejection device of claim 1, comprising a second fluid feed source having a second fluid feed source edge in communication with the substrate surface and second firing resistors, wherein a first portion of the second firing resistors are disposed along the first fluid feed source and configured to respond to a second current to heat fluid provided by the first fluid feed source and a second portion of the second firing resistors are disposed along the second fluid feed source and configured to respond to the second current to heat fluid provided by the second fluid feed source, wherein the reference conductor is configured to conduct the second current from the second firing resistors and is disposed between the first fluid feed source edge and the first portion of the second firing resistors and between the second fluid feed source edge and the second portion of the second firing resistors.

20. The fluid ejection device of claim 1, wherein the reference conductor comprises a conductive layer and a resistive layer.

21. The fluid ejection device of claim 1, comprising:
vaporization chambers fluidically coupled to the first fluid feed source; and
an isolation layer configured to isolate the reference conductor from fluid flowing from the fluid feed source to the vaporization chambers, wherein the reference conductor is disposed between the vaporization chambers and the first fluid feed source edge.

22. A fluid ejection device comprising:
a first fluid feed source having a first fluid feed source edge;
first vaporization chambers fluidically coupled to the first fluid feed source;
a reference conductor disposed between the first vaporization chambers and the first fluid feed source edge; and
an isolation structure configured to isolate the reference conductor from fluid flowing over the first fluid feed source edge to the first vaporization chambers.

23. The fluid ejection device of claim 22, wherein the reference conductor is disposed between at least two of the first vaporization chambers.

24. The fluid ejection device of claim 22, wherein the reference conductor is disposed along opposing sides of the first fluid feed source.

25. The fluid ejection device of claim 22, wherein the first vaporization chambers are disposed along opposing sides of the first fluid feed source and the reference conductor is disposed between the first vaporization chambers and the first fluid feed source edge along one of the opposing sides of the first fluid feed source and the first vaporization chambers and a second fluid feed source edge along another one of the opposing sides of the first fluid feed source.

26. The fluid ejection device of claim 22, comprising fluid paths, wherein each of the fluid paths is fluidically coupled to the first fluid feed source and a corresponding one of the first vaporization chambers and the reference conductor is isolated from fluid flowing through the fluid paths by the isolation structure.

27. The fluid ejection device of claim 22, comprising:
a second fluid feed source having a second fluid feed source edge; and
second vaporization chambers fluidically coupled to the second fluid feed source, wherein the reference conductor is disposed between the second vaporization chambers and the second fluid feed source edge and the isolation structure is configured to isolate the reference conductor from fluid flowing over the second fluid feed source edge to the second vaporization chambers.

28. The fluid ejection device of claim 27, wherein the reference conductor is disposed between at least two of the second vaporization chambers.

29. The fluid ejection device of claim 27, wherein the second vaporization chambers are disposed along opposing sides of the second fluid feed source and the reference conductor is disposed between the second vaporization chambers and the second fluid feed source edge along one of the opposing sides of the second fluid feed source and the second vaporization chambers and a third fluid feed source edge along another one of the opposing sides of the second fluid feed source.

30. The fluid ejection device of claim 22, comprising firing resistors, wherein each of the firing resistors is disposed in a corresponding one of the first vaporization chambers and configured to respond to a current to heat fluid provided by the first fluid feed source and the reference conductor is configured to conduct the current from the firing resistors.

31. The fluid ejection device of claim 30, comprising drive switches, wherein each of the drive switches is electrically coupled between a corresponding one of the firing resistors and the reference conductor.

32. The fluid ejection device of claim 31, wherein the reference conductor is disposed over a portion of the drive switches.

33. The fluid ejection device of claim 31, wherein the reference conductor is disposed between two of the firing resistors.

34. The fluid ejection device of claim 31, wherein the reference conductor is disposed between two of the firing resistors and over a portion of the drive switches.

35. A fluid ejection device comprising:
a first fluid feed source having a first fluid feed source edge;
first firing resistors disposed along the first fluid feed source and configured to respond to a first current to heat fluid provided by the first fluid feed source;
first drive switches disposed along the first fluid feed source, wherein each of the first drive switches is electrically coupled to one of the first firing resistors; and
a reference conductor disposed over a portion of the first drive switches and extending to between the first firing resistors and the first fluid feed source edge.

36. The fluid ejection device of claim 35, comprising vaporization chambers fluidically coupled to the first fluid feed source, wherein each of the first firing resistors is disposed substantially adjacent to a corresponding one of the vaporization chambers and the reference conductor is disposed between the vaporization chambers and the first fluid feed source edge.

37. The fluid ejection device of claim 35, wherein the reference conductor is disposed between at least two of the first firing resistors.

37. The fluid ejection device of claim 35, wherein the reference conductor is disposed between at least two of the first firing resistors and between two of the first drive switches.

38. The fluid ejection device of claim 35, wherein the first firing resistors are disposed on opposing sides of the first fluid feed source and the first drive switches are disposed on the opposing sides of the first fluid feed source, and the reference conductor is disposed over a portion of the first drive switches and between the first firing resistors and the first fluid feed source edge along one of the opposing sides of the first fluid feed source and over a portion of the first drive switches and between a second fluid feed source edge along another one of the opposing sides of the first fluid feed source.

39. The fluid ejection device of claim 35, comprising:
a second fluid feed source having a second fluid feed source edge;
second firing resistors disposed along the second fluid feed source and configured to respond to the first current to heat fluid provided by the second fluid feed source; and
second drive switches disposed along the second fluid feed source, wherein each of the second drive switches is electrically coupled to one of the second firing resistors and the reference conductor is disposed over a portion of the second drive switches and extending to between the second firing resistors and the second fluid feed source edge.

40. The fluid ejection device of claim 35, comprising:
second firing resistors disposed along the first fluid feed source and configured to respond to a second current to heat fluid provided by the first fluid feed source; and
second drive switches disposed along the first fluid feed source, wherein each of the second drive switches is electrically coupled to one of the second firing resistors and the reference conductor is disposed over a portion of the second drive switches and extending to between the second firing resistors and the first fluid feed source edge.

41. The fluid ejection device of claim 35, comprising:
a second fluid feed source having a second fluid feed source edge;
second firing resistors disposed along the second fluid feed source and configured to respond to a second current to heat fluid provided by the second fluid feed source; and
second drive switches disposed along the second fluid feed source, wherein each of the second drive switches is electrically coupled to one of the second firing resistors and the reference conductor is disposed over a portion of the second drive switches and extending to between the second firing resistors and the second fluid feed source edge.

42. A method of operating a fluid ejection device, comprising:
receiving fluid from a first fluid feed source having a first fluid feed source edge in communication with a substrate surface;
receiving a first current at first firing resistors disposed along the first fluid feed source;
heating the fluid received from the first fluid feed source in response to the received first current at the first firing resistors;
receiving the first current from the first firing resistors on a reference conductor; and
conducting a first part of the first current on the reference conductor disposed between the first fluid feed source edge and the first firing resistors.

43. The method of claim 42, comprising:
first firing resistor areas; and
conducting a second part of the first current on the reference conductor disposed between the first firing resistor areas.

44. The method of claim 42, comprising:
gating the first current through drive switches; and
conducting a second part of the first current on the reference conductor over a portion of the drive switches.

45. The method of claim 44, comprising conducting a second part of the first current on the reference conductor along the entire length of the first fluid feed source.

46. The method of claim 44, comprising receiving the first current from the first firing resistors on opposing sides of the first fluid feed source.

47. The method of claim 44, comprising:
receiving a second current at second firing resistors disposed along the first fluid feed source;
heating the fluid received from the first fluid feed source in response to the received second current at the second firing resistors;
receiving the second current from the second firing resistors on the reference conductor; and
conducting part of the second current on the reference conductor disposed between the first fluid feed source edge and the second firing resistors.

48. The method of claim 47, comprising:
receiving fluid from a second fluid feed source having a second fluid feed source edge in communication with the substrate surface;
receiving the first current at second firing resistors disposed along the second fluid feed source;
heating the fluid received from the second fluid feed source in response to the received first current at the second firing resistors; and
conducting a second part of the first current on the reference conductor disposed between the second fluid feed source edge and the second firing resistors.

49. The method of claim 44, comprising:
receiving fluid from a second fluid feed source having a second fluid feed source edge in communication with the substrate surface;
receiving a second current at second firing resistors disposed along the second fluid feed source;
heating the fluid received from the second fluid feed source in response to the received second current at the second firing resistors;
receiving the second current from the second firing resistors on the reference conductor; and
conducting part of the second current on the reference conductor between the second fluid feed source edge and the second firing resistors.

50. A method of operating a fluid ejection device, comprising:
supplying fluid from a fluid feed source over a fluid feed source edge and a reference conductor to vaporization chambers; and
receiving the fluid in the vaporization chambers.

51. A fluid ejection device comprising:
a fluid feed source;
firing resistors disposed along the fluid feed source and configured to respond to a current to heat fluid provided by the fluid feed source; and
a reference conductor configured to conduct the current from the firing resistors, wherein the reference conductor is disposed between two of the firing resistors.

52. The fluid ejection device of claim 51, comprising firing resistor areas disposed along the fluid feed source, wherein the reference conductor is disposed between adjacent firing resistor areas.

53. A fluid ejection device comprising:
a first fluid feed source;
first firing resistors disposed along the first fluid feed source and configured to respond to a first current to heat fluid provided by the first fluid feed source;
first drive switches disposed along the first fluid feed source on a first side of the first firing resistors, wherein each of the first drive switches is electrically coupled to one of the first firing resistors; and
a reference conductor disposed along the first feed source on a second side of the first firing resistors.

54. The fluid ejection device of claim 53, wherein the reference conductor is disposed on the first side of the resistors.

55. A fluid ejection device comprising:
a first fluid feed source;
first vaporization chambers fluidically coupled to the first fluid feed source; and
a reference conductor disposed under a fluid path between the first fluid feed source and the first vaporization chambers.

56. The fluid ejection device of claim 55 comprising:
an isolation structure configured to isolate the reference conductor from fluid flowing through the fluid path.

57. A fluid ejection device comprising:
a first fluid feed source;
a second fluid feed source;
a first fire line adapted to receive a first energy signal comprising energy pulses;
first drop generators fluidically coupled to the first fluid feed source; and
second drop generators fluidically coupled to the second fluid feed source, wherein each of the first drop generators and each of the second drop generators are electrically coupled to the first fire line and configured to respond to the first energy signal to eject fluid.

58. A fluid ejection device comprising:
a first fluid feed source;
a second fluid feed source;
a first fire line adapted to receive a first energy signal comprising energy pulses;
a second fire line adapted to receive a second energy signal comprising energy pulses;
first drop generators fluidically coupled to the first fluid feed source;
second drop generators fluidically coupled to the second fluid feed source; and
third drop generators fluidically coupled to the first fluid feed source, wherein each of the first drop generators and each of the second drop generators are configured to respond to the first energy signal to eject fluid and each of the third drop generators are configured to respond to the second energy signal to eject fluid.

59. A fluid ejection device comprising:
a first fluid feed source;
first drop generators fluidically coupled to the first fluid feed source; and
a first fire line adapted to receive a first energy signal comprising energy pulses, wherein the first drop generators are configured to respond to the first energy signal to eject fluid and the first fire line comprises a layered portion comprising a first conductive layer and a second conductive layer electrically coupled to the first conductive layer.

60. A fluid ejection device comprising:
a first fluid feed source;
a second fluid feed source;
first drop generators fluidically coupled to the first fluid feed source and disposed between the first fluid feed source and the second fluid feed source;
second drop generators fluidically coupled to the first fluid feed source and disposed between the first fluid feed source and the second fluid feed source;
a first fire line adapted to receive a first energy signal comprising energy pulses; and
a second fire line adapted to receive a second energy signal comprising energy pulses, wherein each of the first drop generators are electrically coupled to the first fire line and each of the second drop generators are electrically coupled to the second fire line, and the first fire line is disposed adjacent the second fire line and bypasses the second drop generators between the first fluid feed source and the second fluid feed source.

61. A fluid ejection device comprising:
means for receiving fluid from a first fluid feed source;
means for receiving fluid from a second fluid feed source;
means for receiving a first energy signal comprising energy pulses;
means for responding to the first energy signal to eject fluid received from the first fluid feed source;
means for responding to the first energy signal to eject fluid received from the second fluid feed source, wherein the means for receiving the first energy signal is electrically coupled to the means for responding to the first energy signal to eject fluid received from the first fluid feed source and the means for responding to the first energy signal to eject fluid received from the second fluid feed source.

62. A method of operating a fluid ejection device comprising:
receiving fluid from a first fluid feed source in first drop generators;
receiving fluid from a second fluid feed source in second drop generators;
receiving a first energy signal comprising energy pulses in a first fire line; and
responding to the first energy signal to eject fluid from the first drop generators and the second drop generators.
